(19) United States
(12) Patent Application Publication
(10) Pub. No.: US 2012/0179281 A1
(43) Pub. Date: Jul. 12, 2012

(54) SYSTEMS FOR DENTURE PREPARATION

(75) Inventors: Robert Steingart, Wellesley, MA (US); Yakov Epelbaum, Medford, MA (US); Larry Bodony, Lexington, MA (US); David T. Chen, Wrentham, MA (US); John Orfanidis, Walpole, MA (US); Russell Giordano, II, Marlborough, MA (US); Alain D. Carballeyra, Wilmington, MA (US); Peter Waksman, Concord, MA (US)

(73) Assignee: SENSABLE TECHNOLOGIES, INC., Wilmington, MA (US)

(21) Appl. No.: 13/208,987

(22) Filed: Aug. 12, 2011

Related U.S. Application Data
(60) Provisional application No. 61/373,785, filed on Aug. 13, 2010.
(60) Provisional application No. 61/445,960, filed on Feb. 23, 2011.

(51) Int. Cl. G06G 7/60; G06F 19/00

(52) U.S. Cl. 700/97; 703/11

(57) ABSTRACT

Embodiments of the invention generally relate to systems and methods for designing and manufacturing dentures. More particularly, in certain embodiments, the invention relates to a system for preparing a denture base plate. The system includes a user interface and a design application for creating a virtual model, and a manufacturing apparatus for fabricating a denture base plate corresponding to the virtual model. In other embodiments, an apparatus is provided that includes a graphical interface and a design application for selecting a set of virtual denture teeth and placing and adjusting the virtual denture teeth in relation to each other and a virtual denture base plate.

### CROSS-REFERENCE TO RELATED APPLICATION

This application claims priority to and the benefit of, and incorporates herein by reference in their entireties U.S. Provisional Patent Application No. 61/373,785, which was filed on Aug. 13, 2010, and U.S. Provisional Patent Application No. 61/445,960, which was filed on Feb. 23, 2011.

### TECHNICAL FIELD

Embodiments of the invention generally relate to systems and methods for designing and manufacturing full dentures and/or partial dentures.

### BACKGROUND

Manufacturing traditional dentures requires five visits to a dentist by a patient, and four separate lab procedures. Additional visits to the dentist are often needed to achieve a good-fitting final denture. FIG. 1 illustrates a typical prior-art procedure 100 for manufacturing a pair of dentures, such as the dentures 200 shown in FIG. 2. FIG. 3 is an illustration of the dentist-side portion of the process.

During a first visit 102, the dentist takes a preliminary impression of the patient's mouth. The preliminary impression is a rough impression that captures the basic shape of the patient's gums, but does not have the precision and accuracy required for a final denture.

The dentist sends the completed preliminary impression to a lab and, in a first lab step 104, the lab creates a custom tray, such as the custom tray 402 on the preliminary impression 404 in FIG. 4. The custom tray includes an offset space of approximately 1 mm so that the dentist can apply a thin layer of low viscosity impression material on the surface of the custom tray, which is sent back to the dentist for a second visit 106.

In the second visit 106, the custom tray (having the impression material disposed thereon) is inserted in the patient's mouth to create a final impression, which is then sent back to the lab.

The lab receives the final impression in a second lab step 108 and produces a stone master model 500 therefrom, as illustrated in FIG. 5. Using the stone model 500, the lab produces a denture base plate 600, typically using a light-cured plastic or thermoplastic, and adds a wax bite rim 602 to the base plate 600. The denture base plate 600 with the bite rim 602, shown in FIG. 6, is then sent back to the dentist for a third patient visit 110.

During the third dentist visit 110, the dentist inserts the denture base plate 600 with the bite rim 602 in the patient's mouth. The base plate/bite rim combination is used primarily as a temporary platform for taking measurements (e.g., occlusion, fit); because the denture base plate 600 does not accurately model the patient's mouth (e.g., it does not have undercuts), it does not fit tightly to the entire tissue surface, as does the final denture. During the third dentist visit, a variety of measurements are taken to fit the base plate 600 and bite rim 602 to the patient's mouth, and the bite rim may 602 be adjusted by the dentist (by, e.g., cutting or melting away or adding wax). For some of the measurements (e.g., midline), the dentist may make physical marks on the bite rim 602.

Other measurements taken during the third dentist visit 110 may include: horizontal plane with pitch, yaw and roll; upper and lower height to occlusal plane; face bow transfer (e.g., relation of the occlusal plane to the articulator hinge); smile line (i.e., a line that follows the shape of the patient's upper lip); canine to canine distance; midline; relaxed state (i.e., speaking or “freeway” space), typically 2-3 mm; excursive movements (e.g., 2D edge to edge, lateral, and protrusive); vertical dimension at occlusion (“VDO”); vertical dimension at rest (“VDR”); lip protrusion (i.e., the amount of space required behind the upper lip to create an acceptable patient profile); tooth selection (e.g., shape of tooth based on the shape of the patient's head and the patient's gender, width of tooth based on canine to canine distance, and/or length of tooth based upon distances to the occlusal plane); and/or color based on shade guide.

FIGS. 7-9 illustrate various measurements taken. FIG. 7, for example, illustrates determining vertical dimension and interpupillary plane; FIG. 8 illustrates facebow registration; and FIG. 9 illustrates centric relation registration. FIG. 10 illustrates tooth and shade selection.

The initial measurements taken during the third dentist visit 110 (e.g., height of the bite rim 602, typically 22 mm for the maxillary, 18 mm for the mandible) are set at the lab for a third lab step 112 for set-up, as illustrated in FIG. 11. The lab may also use other measurements taken during the second lab step 108, such as measurements for the retromolar pads, ridge, and vestibule used in creating the denture base plate 600 and bite rim 602. The lab sets the stone models in an articulator and places physical denture teeth into the wax bite rim.

In a fourth patient visit 114, the dentist fits the base plate 600, bite rim 602, and denture teeth into the patient's mouth and tests for occlusion (e.g., making sure the patient's mouth closes properly and comfortably with the denture teeth inside). Because the base plate 600 does not accurately reflect the patient's mouth and gum structure, however, the dentist is limited in the conclusions that may be drawn about the eventual fit of the dentures based on the fit of the base plate 600.

Based on information from the fourth dentist visit 114, the lab, in a fourth lab step 116, prepares the final dentures from the base plate 600 and bite rim 602. A plaster cast 1200 holds the denture teeth 1202 in place while the wax bite rim 1204 is melted away and replaced with a permanent material (e.g., polyurethane, nylon or acrylic), as shown in FIG. 12. The dentures are cleaned and polished and returned to the dentist for a fifth and final dentist visit 118.

In the fifth dentist visit 118, the dentist makes final adjustments to the dentures. Because the base plate 600 used in the try-in visit 114 was not accurate, the dentist may need to adjust the base of the dentures to account for a previously unknown feature of the patient's mouth (e.g., a bone spur).

As described above, there are many well-known techniques and criteria for setting denture teeth by hand. Thus far, however, it has been difficult to implement these techniques and criteria on a computer (e.g., in a computerized CAD/CAM system).

Thus, the existing process for creating dentures uses many steps, relies heavily on the individual skill of the dentist and/or lab technicians, and may produce dentures of less-than-ideal fit. A need exists for a way to create dentures in fewer steps and to automate and standardize the creation procedure.

### SUMMARY

The systems and methods described herein improve the process of designing and manufacturing dentures. In preferred embodiments, the systems and methods result in a reduction in the number of chairside dentist visits, they reduce the time spent per chairside visit, they improve the productivity of the lab, and they provide a better-fitting denture. In various embodiments, the number of chairside visits may be reduced from five to four or from five to three. Because chairside time may average $500 in revenue per hour, these savings may provide a compelling return on investment for the dentist. The time spent per chairside visit may decrease by providing better-fitting parts, that require fewer adjustments by the dentist, sooner in the process. Measuring the patient's characteristics digitally may capture the measurements in a more reliable, faster, and accurate fashion.

In addition, lab productivity may be improved by reducing direct labor time by at least a factor of 2×, with a return-on-investment payback of less than two years for a lab producing less than ten dentures per day. Using portal-based supply chains, greater efficiencies and savings for supply chain ordering of denture teeth and related materials may be provided. A better fitting denture may be provided in less time, thereby benefiting the patient, dentist, and lab. For example, the time for festooning and arranging teeth in a single arch may be reduced from about 60 minutes to about 10 minutes. Embodiments of the present invention provide a complete process, from beginning to end, that is natural and intuitive for the dentist to ensure quick adoption. By using a digital process, the ordering of replacement dentures, which typically need to be replaced every 5-10 years, may be done more quickly.

A graphical user interface (GUI) is presented which allows a dentist, technician, or other denture designer to place and adjust individual teeth in a set of dentures in an extremely intuitive way. By providing a user-friendly interface for 6-DOF manipulation of individual teeth—translation and rotation with respect to three dentally-significant axes—the GUIs offer rapid, accurate, and easier design of a set of dentures. The three axes are a tooth direction axis (mesial-distal direction axis), a buccal-lingual direction axis, and a tooth long axis. By providing each tooth its own set of dentally significant axes, the user is provided a vast improvement over manipulation in standard x-y-z coordinates or other coordinate system that is the same for all teeth in the set of dentures, since the adjustment of individual teeth in arbitrary, unnatural directions is prevented. The GUIs provide a powerful tool for the creation of a 3D model of a set of dentures, which can then be used to manufacture the set of dentures.

In one aspect, the invention relates to an apparatus for adjusting a position of one or more virtual teeth in a model of a set of dentures. The apparatus includes a memory for storing a code defining a set of instructions, and a processor for executing the set of instructions, wherein the code includes a graphical user interface (GUI) module configured to provide a graphical user interface element. The graphical user interface element includes at least one active location for: (i) translating one or more selected virtual teeth along a tooth direction axis; (ii) rotating the one or more selected virtual teeth about the tooth direction axis; (iii) translating the one or more selected virtual teeth along a buccal-lingual axis; (iv) rotating the one or more selected virtual teeth about the buccal-lingual axis; (v) translating the one or more selected virtual teeth along a tooth long axis; and (vi) rotating the one or more selected virtual teeth about the tooth long axis. The description of elements of the embodiments above can be applied to this aspect of the invention as well.

In certain embodiments, the GUI module is configured to graphically display the one or more selected virtual teeth in relation to the tooth direction axis, the buccal lingual axis, and the tooth long axis. In one embodiment, the GUI module is configured to graphically display the one or more selected virtual teeth in relation to at least one of the a direction curve and an occlusal plane. In another embodiment, the GUI module is configured to graphically display the one or more selected virtual teeth in relation to one another. The buccal-lingual axis may be substantially perpendicular to an occlusal plane normal and a bite rim curve. The apparatus may also include a display to graphically display the one or more selected virtual teeth.

In preferred embodiments, the tooth direction axis of a given tooth is its mesial-distal direction. In certain embodiments, the GUI module is configured to permit recording a series of user activities for repeated performance upon user command. In certain embodiments, each of the axes is determined for each of the one or more virtual teeth using a bite rim wax scan and a lower jaw scan. In certain embodiments, the GUI module is configured to allow user selection of multiple teeth and manipulation of more than one tooth at a time. In certain embodiments, the GUI module is configured to allow user manipulation of a plurality of virtual teeth at a time, all with respect to the tooth direction axis, the buccal-lingual axis, and the tooth long axis of a single virtual tooth among the plurality of virtual teeth. In certain embodiments, the GUI module is configured to allow user manipulation of a plurality of virtual teeth at a time, each tooth with respect to its own tooth direction axis, buccal-lingual axis, and tooth long axis.

In another aspect, the invention relates to an apparatus for automatically positioning virtual teeth in a model of a set of dentures. The apparatus includes a memory for storing a code defining a set of instructions, and a processor for executing the set of instructions. The code includes a virtual tooth placement module configured to define a bite rim curve, an occlusal plane, and a plurality of virtual teeth, wherein each of the virtual teeth is associated with a local coordinate system that includes a tooth direction axis, a buccal-lingual axis, and a tooth long axis. The virtual tooth placement module is also configured to position each virtual tooth in the set of dentures such that, for each virtual tooth, (i) the tooth direction axis is parallel to a line tangent to the bite rim curve and parallel to the occlusal plane, (ii) the buccal-lingual axis is perpendicular to the bite rim curve and parallel to the occlusal plane, and (iii) the tooth long axis is perpendicular to the bite rim curve and perpendicular to the occlusal plane. The description of elements of the embodiments above can be applied to this aspect of the invention as well.

In certain embodiments, the virtual tooth placement module is configured to position the origin for a virtual tooth onto (or near) the bite rim curve. In one embodiment, the virtual tooth placement module is configured to measure at least one of a lateral spacing between adjacent virtual teeth and a vertical spacing between opposing virtual teeth, and adjust at least one of the lateral spacing and the vertical spacing, to ensure virtual teeth do not overlap, the lateral spacing between virtual teeth is not excessive, and opposing virtual teeth meet in proper occlusion (e.g., are in contact but do not overlap). In another embodiment, the virtual tooth placement module is configured to translate a virtual tooth, in accordance with user input, along at least one of the tooth direction axis, the buccal-lingual axis, and the tooth long axis. In yet another embodiment, the virtual tooth placement module is configured to rotate a virtual tooth, in accordance with user input, about at least one of the tooth direction axis, the buccal-lingual axis, and the tooth long axis. In still another embodiment, the virtual tooth placement module is configured to simulate a biting configuration between upper virtual teeth and lower virtual teeth, and calculate at least one of occlusal intereference and interference between adjacent teeth, based on the simulated biting configuration.

In certain embodiments, the apparatus includes a display to graphically display one or more virtual teeth. The display may be configured to display in color at least one of occlusal intereference and interference between adjacent teeth. In one embodiment, the virtual tooth placement module is configured to translate one or more virtual teeth until a cusp of a virtual tooth is centered within a groove of an opposing virtual tooth. In another embodiment, the virtual tooth placement module is configured to translate one or more virtual teeth until a cusp of a virtual tooth is centered within a groove of an opposing virtual tooth. In yet another embodiment, the virtual tooth placement module is configured to apply a tooth position macro to adjust the position of one or more virtual teeth. A virtual tooth may include a cusp, an opposing virtual tooth may include a groove, and the virtual tooth placement module may be configured to adjust a position of the virtual tooth to center the cusp within the groove.

In another aspect, the invention relates to an apparatus for automatically positioning virtual teeth in a model of a set of dentures. The apparatus includes a memory for storing a code defining a set of instructions, and a processor for executing the set of instructions. The code includes a virtual tooth placement module configured to define a bite rim curve, an occlusal plane, and a plurality of virtual teeth, wherein each of the virtual teeth is associated with a local coordinate system that includes a tooth direction axis. The virtual tooth placement module is also configured to position each tooth along the bite rim curve such that, for each tooth, the tooth direction axis is parallel to a line tangent to the bite rim curve. The description of elements of the embodiments above can be applied to this aspect of the invention as well.

In certain embodiments, the local coordinate system includes a buccal-lingual axis, and the virtual tooth placement module is configured to position each tooth such that, for each tooth, the buccal-lingual axis is perpendicular to the bite rim curve and parallel to the occlusal plane. In one embodiment, the local coordinate system includes a long axis, and the virtual tooth placement module is configured to position each tooth such that, for each tooth, the long axis is perpendicular to the bite rim curve and perpendicular to the occlusal plane.

In another aspect, the invention is directed to an apparatus for preparing a customized oral (e.g., dental and/or gum) impression tray (e.g., said impression tray suitable for use in preparation of full or partial dentures), the apparatus including a preform (e.g., a thermoplastic preform) including a flexible spacer layer (e.g., about 1 mm, e.g., from 0.5 mm to 1.5 mm) configured to contact patient tissue, said spacer layer removably affixed to said preform, wherein said preform is configured to be molded over said patient tissue with said spacer layer affixed thereto and thereafter said spacer layer removed, thereby forming an impression tray with a clearance into which oral impression material may be introduced for creation of a detailed oral impression, wherein said preform is malleable at a first temperature to enable molding over said patient tissue (e.g., said first temperature is suitable for contact with patient tissue without burning) and wherein said preform hardens at a second temperature, lower than said first temperature, thereby forming said tray.

In another aspect, the invention relates to a system for preparing a denture base plate for use in the preparation of dentures. The system includes a user interface configured to receive input from a user, and a design application in communication with the user interface. The design application is configured to create an initial virtual model using scan data corresponding to a stone or a patient situation. The design application includes a virtual block-out wax tool configured to modify the initial virtual model by adding virtual block-out wax onto a user-defined region of the initial virtual model to partially or completely fill in one or more undercut portions of the model and to smooth irregularities on the surface of the initial virtual model. The design application is configured to update the initial virtual model to include the added virtual block-out wax upon a user command, and is further configured to create a virtual denture base plate conforming to the updated virtual model. The system also includes a manufacturing apparatus for fabrication of a denture base plate corresponding to the virtual denture base plate. The manufacturing apparatus is capable of fabricating a denture base plate with one or more undercuts. The description of elements of the embodiments above can be applied to this aspect of the invention as well.

In certain embodiments, the design application allows the user to specify a thickness of the virtual block out wax. In one embodiment, the design application allows the user to specify a denture border. The manufacturing apparatus may include a rapid prototyping machine and/or a milling machine. The milling machine may be for milling the denture base plate from a biocompatible material such as an acrylic, plastic, or various composite materials. In another embodiment, the denture base plate comprises a final prosthetic. The denture base plate may be used in a flasking step.

In another aspect, the invention relates to an apparatus for preparing a virtual denture base plate. The apparatus includes (a) memory that stores code defining a set of instructions, and (b) a processor that executes said instructions thereby to: (i) create a model from a scan of a dental model, dental impression, or a patient situation; (ii) add virtual block-out wax to the model to fill in an undercut portion of the model, a defective portion of the model, or both; and (iii) update the model to incorporate the added virtual block-out wax and virtual relief wax upon a user command, thereby preparing a virtual refractory model onto which a virtual denture base can be built. The description of elements of the embodiments above can be applied to this aspect of the invention as well. In certain embodiments, the processor executes the instructions to update the model to incorporate denture border information, as specified by a user.

In another aspect, the invention relates to a method of preparing a denture base plate for use in the preparation of dentures. The method includes the steps of: (i) creating a model from a scan of a dental stone, dental impression, or a patient situation; (ii) adding virtual block-out wax to the model to fill in an undercut portion of the model, a defective portion of the model, or both; and (iii) updating the model to incorporate the added virtual block-out wax and virtual relief wax upon a user command, thereby preparing a virtual refractory model onto which a virtual denture base can be built. The description of elements of the embodiments above can be applied to this aspect of the invention as well.

In another aspect, the invention relates to a system for virtual set-up of denture teeth to conform to a virtual denture base plate. The system includes a graphical interface configured to provide graphical feedback to the user; and a design application in communication with the graphical interface. The design application includes a model of a custom denture base plate. The design application uses measurements of a patient situation, and measurements of a detailed oral impression to select a set of virtual denture teeth and to place each of said virtual denture teeth in relation to said virtual denture base plate. The description of elements of the embodiments above can be applied to this aspect of the invention as well.

In certain embodiments, the design application uses (i) the cusp angle of the denture teeth selected by the dentist, (ii) knowledge of teeth balancing as a virtual articulator is moved throughout an excursive range of motion, and (iii) physics-based interactions between neighboring or opposing teeth where collisions and interference are calculated. In another embodiment, the design application also uses measurements determined by a virtual articulator to perform at least one of (i) readjustment of positions of the virtual denture teeth and (ii) placement each of said virtual denture teeth in relation to said virtual denture base plate.

In another aspect, the invention relates to a system for preparing a custom gingival structure (bite rim) for use in the preparation of dentures. The system includes a user interface configured to receive input from a user, and a design application in communication with the user interface, wherein the design application is configured to create a virtual model of a custom bite rim corresponding to a virtual denture base plate, and a set of virtual denture teeth. The system also includes a manufacturing apparatus for fabrication of the custom bite rim from the virtual model of the custom bite rim. The description of elements of the embodiments above can be applied to this aspect of the invention as well.

In certain embodiments, the manufacturing apparatus includes a rapid prototyping machine and/or a milling machine. The milling machine may be for milling the custom bite rim in material with plastic qualities such as plastic, thermoplastic, or wax.

In another aspect, the invention relates to a customized denture work-up for adjustment prior to fabrication of final dentures. The denture work-up includes a biocompatible denture base plate, and a digitally fabricated bite rim or wax bite rim attached to the denture base plate. The description of elements of the embodiments above can be applied to this aspect of the invention as well. In certain embodiments, the customized denture work-up includes denture teeth held in place in relation to at least one of the denture base plate and the bite rim with a material.

In another aspect, the invention relates to a method of performing a try-in of a denture work-up for adjustment prior to fabrication of final dentures. The method includes the steps of: obtaining a customized denture work-up comprising a biocompatible denture base plate and a bite rim attached to the denture base plate, fitting the denture work-up in a patient's mouth, and adjusting the denture work-up according to fit onto patient tissue and according to occlusion. The description of elements of the embodiments above can be applied to this aspect of the invention as well.

In certain embodiments, the adjusting step includes grinding portions of the denture base plate to accommodate for at least one of a bone spur and an area of discomfort. In one embodiment, the adjusting step includes adjusting one or more of the denture teeth of the customized denture work-up by softening the material holding the tooth/teeth in place and adjusting the position of the tooth/teeth. In another embodiment, the adjusting step includes adding wax material. The method may also include the step of scanning the adjusted denture work-up. In yet another embodiment, the scanning step includes redesigning the optimal teeth placement. In still another embodiment, the method reduces flasking error.

In another aspect, the invention relates to a system for fabricating artificial tooth. The system includes: a user interface configured to receive input from a user; a design application in communication with the user interface, wherein the design application is configured to create a 3D voxel-based model of a tooth, wherein each voxel is assigned one or more of the following properties: color, translucency, hardness, modulus, dynamic modulus; and a rapid prototyping machine for fabrication of the artificial tooth. The rapid prototyping machine is configured to fabricate the artificial tooth via additive manufacturing using the 3D voxel-based model. Properties of the voxels of the model correspond to properties of the voxels of the fabricated tooth. The description of elements of the embodiments above can be applied to this aspect of the invention as well.

In another aspect, the invention relates to a method for making dentures. The method includes the steps of: providing an upper model, a lower model, and an articulation model; scanning the upper model, the lower model, and the articulation model to create a virtual scanned upper model, a virtual scanned lower model, and a virtual scanned articulation model; selecting a teeth card; defining an occlusal curve on the scanned articulation model; defining curves on the scanned articulation model to establish a patient-specific coordinate system; automatically positioning teeth from the selected teeth card relative to the scanned upper and lower models, based on indicated geometry; adjusting a position of at least one tooth; performing virtual articulation of the scanned upper and lower models with the positioned teeth to assess occlusal interference; embossing a virtual denture base on the scanned upper and lower models; creating a gingival structure on top of the virtual denture base that includes holes for the positioned teeth; automatically deriving a gum line for the gingival structure from at least one of (i) curves embedded in a tooth library and (ii) a height of a tooth contour; adding gum features to the gingival structure; determining portions to be removed from the positioned teeth to ensure none of the positioned teeth protrude past a bottom of the denture base; consolidating the denture base and the gingival structure into a consolidated denture base; recreating holes for the teeth, based on final tooth shapes and positions; and producing the consolidated denture base for try-in and final fitting to the patient. The description of elements of the embodiments above can be applied to this aspect of the invention as well.

In certain embodiments, the method includes the step of milling or printing a physical denture base for flasking the denture, wherein the physical denture base is based on the consolidated denture base. The method may also include the step of milling or printing a physical denture base for a final denture, wherein the physical denture base is based on the consolidated denture base. In one embodiment, the method includes the step of milling or printing a cutting jig for shaping the teeth. The scanned upper and lower models may be surveyed and blocked out for creating a try-in denture. The embossing step may include making the denture base thinner in a palette. In another embodiment, gum features are added automatically. In yet another embodiment, the teeth card is selected automatically.

Headers are provided herein for the convenience of the reader—they are not intended to limit the interpretation of the claims.

### BRIEF DESCRIPTION OF THE DRAWINGS

The objects and features of the invention can be better understood with reference to the drawings described below, and the claims. The drawings are not necessarily to scale, emphasis instead generally being placed upon illustrating the principles of the invention. In the drawings, like numerals are used to indicate like parts throughout the various views.

While the invention is particularly shown and described herein with reference to specific examples and specific embodiments, it should be understood by those skilled in the art that various changes in form and detail may be made therein without departing from the spirit and scope of the invention.

FIG. 1 is a schematic diagram depicting the steps required to create initial and custom trays;

FIG. 2 is a photograph of a pair of dentures;

FIG. 3 depicts the dentist-side portion of the denture-making process

FIG. 4 is a photograph of a custom tray on a preliminary impression;

FIG. 5 depicts a stone master model;

FIG. 6 depicts a denture base plate with a bite rim;

FIG. 7 is a schematic diagram illustrating the vertical dimension and interpupillary plane;

FIG. 8 is a photograph depicting the process of facebow registration;

FIG. 9 depicts the process of centric relation registration;

FIG. 10 depicts a selection of teeth and shades;

FIG. 11 depicts the laboratory step of tooth setup;

FIG. 12 is a photograph of a manufacturing step for a Valplast flexible denture;

FIG. 13 is a schematic side view of an intra-oral scanner having multiple charge-coupled devices, according to an illustrative embodiment of the invention;

FIG. 14 is a cross-sectional view of a structure having an undercut, according to an illustrative embodiment of the invention;

FIG. 15 is a flowchart depicting a method for setting denture teeth, according to an illustrative embodiment of the invention;

FIG. 16 is a perspective view of a virtual posterior tooth, according to an illustrative embodiment of the invention;

FIG. 17 is a perspective view of a virtual tooth having a local coordinate system, according to an illustrative embodiment of the invention;

FIG. 18 is a perspective view of a scan of an upper jaw and a lower jaw, according to an illustrative embodiment of the invention;

FIG. 19a is a perspective view of a scan of an upper jaw and a lower jaw, according to an illustrative embodiment of the invention;

FIG. 19b is a schematic perspective view of extension lines passing through canine locations and retro-molar pads, according to an illustrative embodiment of the invention;

FIG. 20 is a perspective view of a scan of an articulation model, including the upper jaw, lower jaw, and wax bite rim, according to an illustrative embodiment of the invention;

FIG. 21 is a screenshot of virtual upper anterior teeth, according to an illustrative embodiment of the invention;

FIG. 22 is a screenshot of virtual upper anterior and posterior teeth, according to an illustrative embodiment of the invention;

FIG. 23 is a screenshot of virtual upper anterior and posterior teeth and virtual lower posterior teeth, according to an illustrative embodiment of the invention;

FIG. 24 is a screenshot of virtual upper anterior and posterior teeth, and virtual lower posterior and anterior teeth, according to an illustrative embodiment of the invention;

FIG. 25 is a schematic perspective view of a haptic device, according to an illustrative embodiment of the invention;

FIG. 26 is a schematic depiction of a virtual articulator, according to an illustrative embodiment of the invention;

FIG. 27 is a schematic depiction of collisions between upper teeth and lower teeth, according to an illustrative embodiment of the invention;

FIG. 28 is a schematic depiction of selection and performance of protrusive motion, according to an illustrative embodiment of the invention;

FIG. 29 is a photograph of denture teeth, according to an illustrative embodiment of the invention;

FIG. 30 is a photograph of denture teeth, according to an illustrative embodiment of the invention;

FIG. 31 is a photograph of a record base, according to an illustrative embodiment of the invention;

FIG. 32 is a schematic perspective view of three digital sensors, according to an illustrative embodiment of the invention;

FIG. 33 is a schematic perspective view of a sensor system, according to an illustrative embodiment of the invention;

FIG. 34 is a schematic perspective view of sensor posts, a tip, and a touch sensitive area, according to an illustrative embodiment of the invention;

FIG. 35a is a schematic top view of a system for performing smile-related and centric measurements, according to an illustrative embodiment of the invention;

FIG. 35b is a schematic front view of a system for performing smile-related and centric measurements, according to an illustrative embodiment of the invention;

FIG. 36 is a photograph of a base plate resting on a stone model made from a patient impression, according to an illustrative embodiment of the invention;

FIG. 37 is a schematic diagram depicting artificial denture teeth with waxing used to create a natural looking gum line, according to an illustrative embodiment of the invention;

FIG. 38 depicts a flowchart of workflow steps used to create a flexible partial denture using a digital denture base and a perfect try-in, according to an illustrative embodiment of the invention;

FIG. 39 is a screenshot of a virtual 3D model of a patient situation, according to an illustrative embodiment of the invention;

FIG. 40 is a screenshot of a digital survey used to determine the proper depth of undercuts, according to an illustrative embodiment of the invention;

FIG. 41 is a screenshot depicting a case in which a tooth library is not utilized;

FIG. 42 is a photograph of a flexible perfect try-in that includes wax used to set denture teeth in the correct locations, according to an illustrative embodiment of the invention;

FIG. 43 is a photograph of a Valplast model invested in a flask, according to an illustrative embodiment of the invention;

FIG. 44 is a photograph of a flexible denture that has been removed from a mold and trimmed and polished, according to an illustrative embodiment of the invention;

FIG. 45 is a photograph of a denture fit back to an original stone, according to an illustrative embodiment of the invention;

FIG. 46 is a flowchart depicting a method used to produce full dentures, according to an illustrative embodiment of the invention; and

FIGS. 47a-d depict schematic views of a cutting jig, according to an illustrative embodiment of the invention.

### DETAILED DESCRIPTION

It is contemplated that devices, systems, methods, and processes of the claimed invention encompass variations and adaptations developed using information from the embodiments described herein. Adaptation and/or modification of the devices, systems, methods, and processes described herein may be performed by those of ordinary skill in the relevant art.

Throughout the description, where devices and systems are described as having, including, or comprising specific components, or where processes and methods are described as having, including, or comprising specific steps, it is contemplated that, additionally, there are devices and systems of the present invention that consist essentially of, or consist of, the recited components, and that there are processes and methods according to the present invention that consist essentially of, or consist of, the recited processing steps.

It should be understood that the order of steps or order for performing certain actions is immaterial so long as the invention remains operable. Moreover, two or more steps or actions may be conducted simultaneously.

The mention herein of any publication, for example, in the Background section, is not an admission that the publication serves as prior art with respect to any of the claims presented herein. The Background section is presented for purposes of clarity and is not meant as a description of prior art with respect to any claim.

### Impression

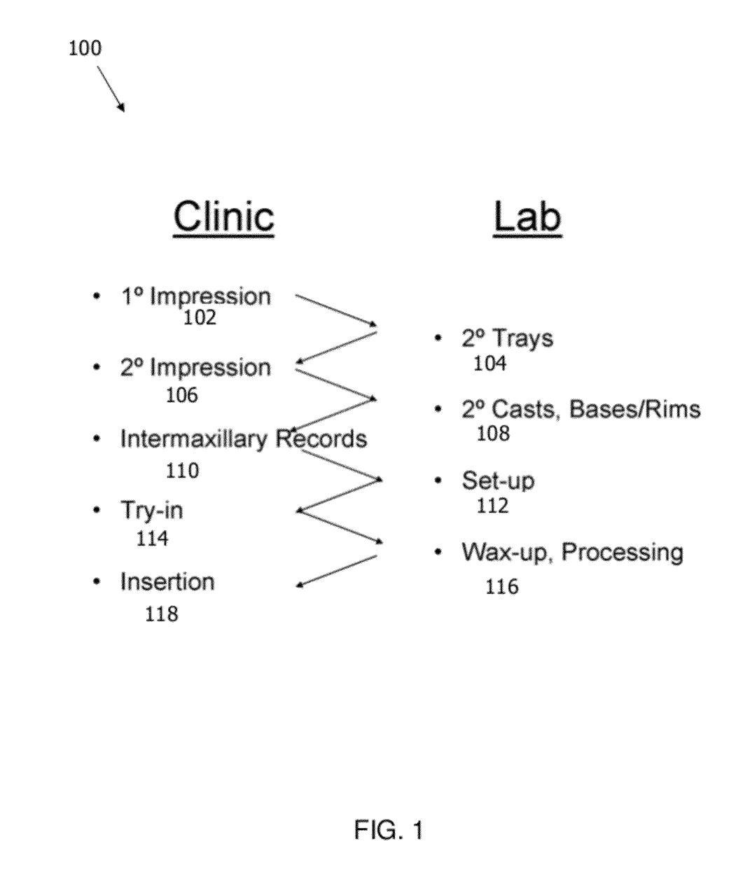

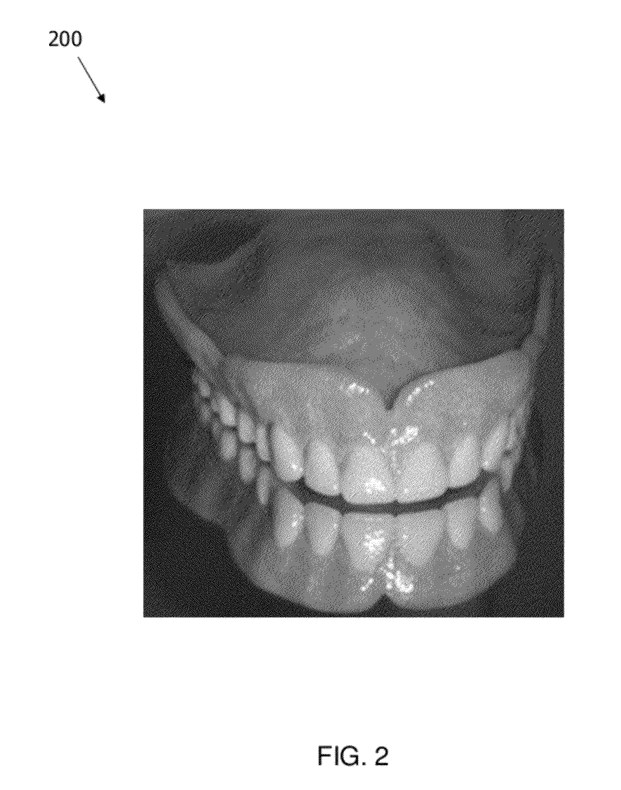

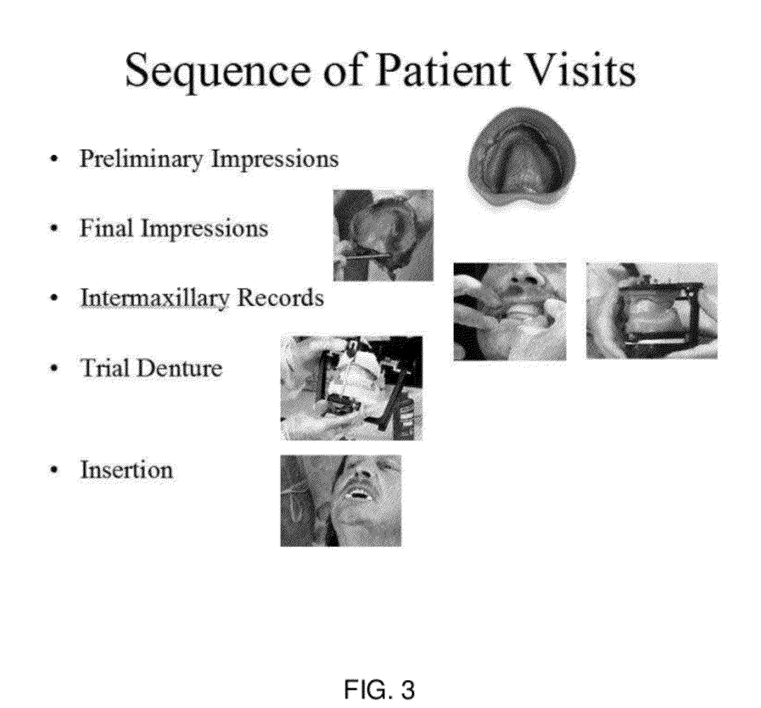

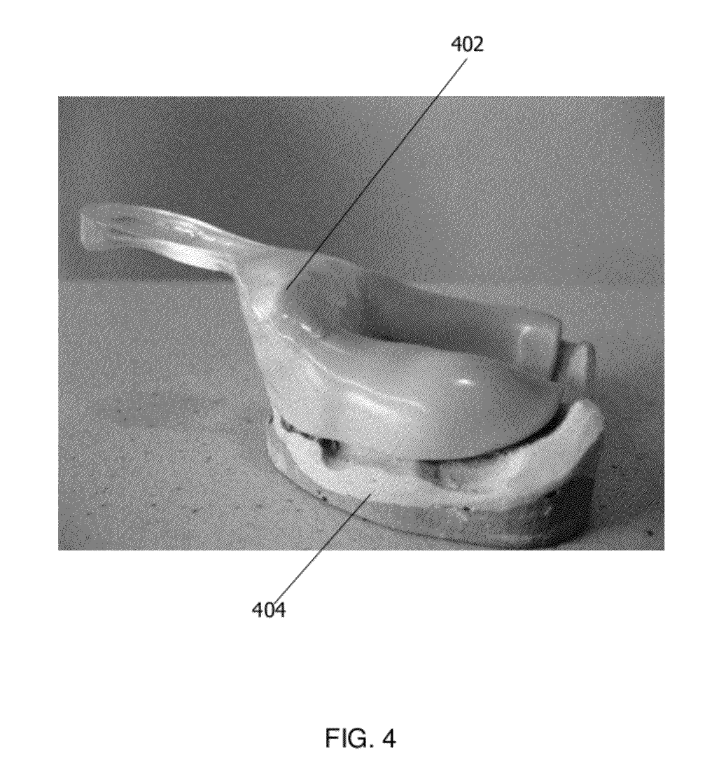

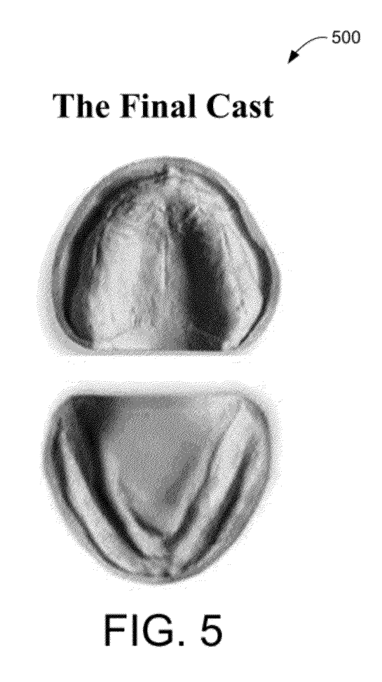

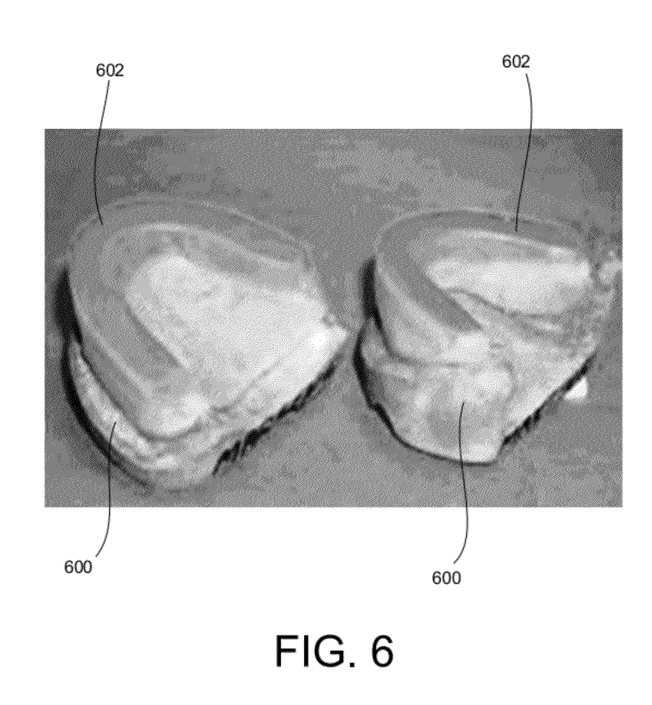

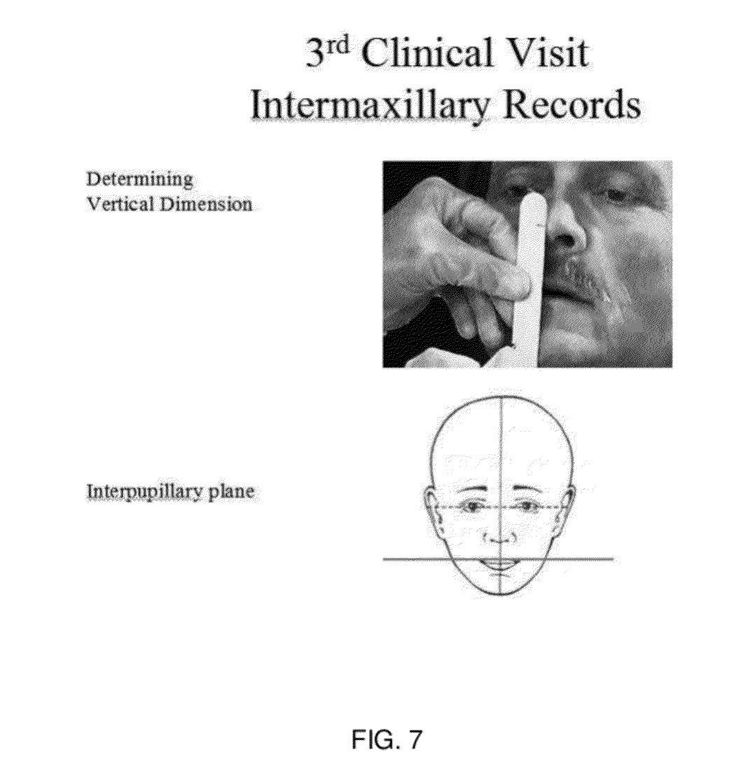

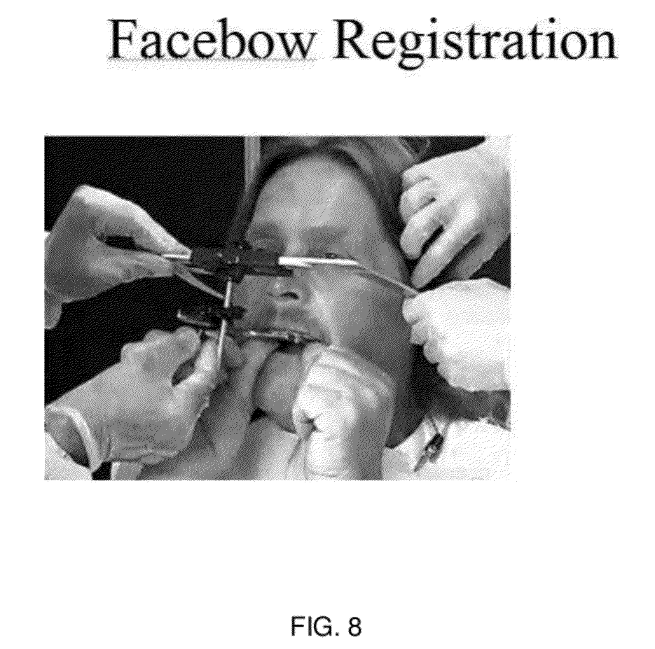

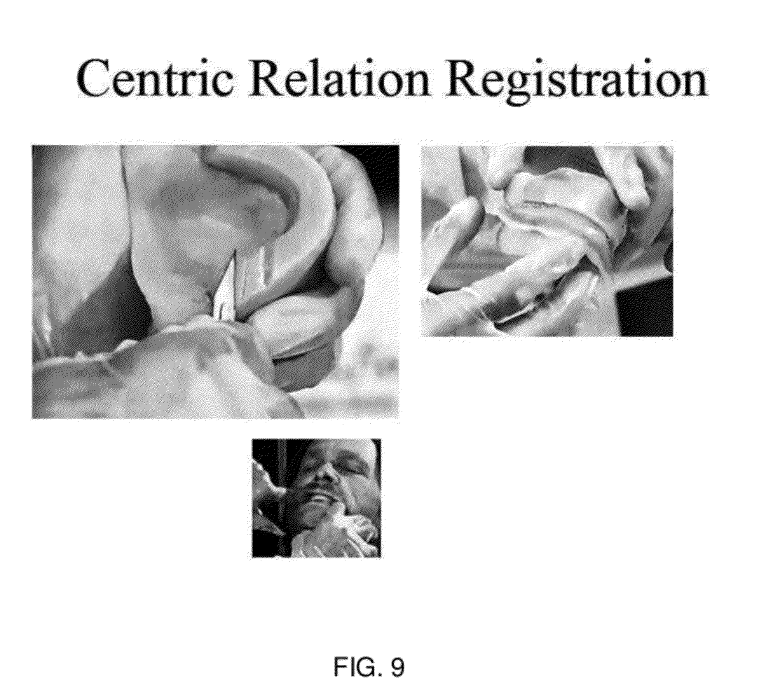

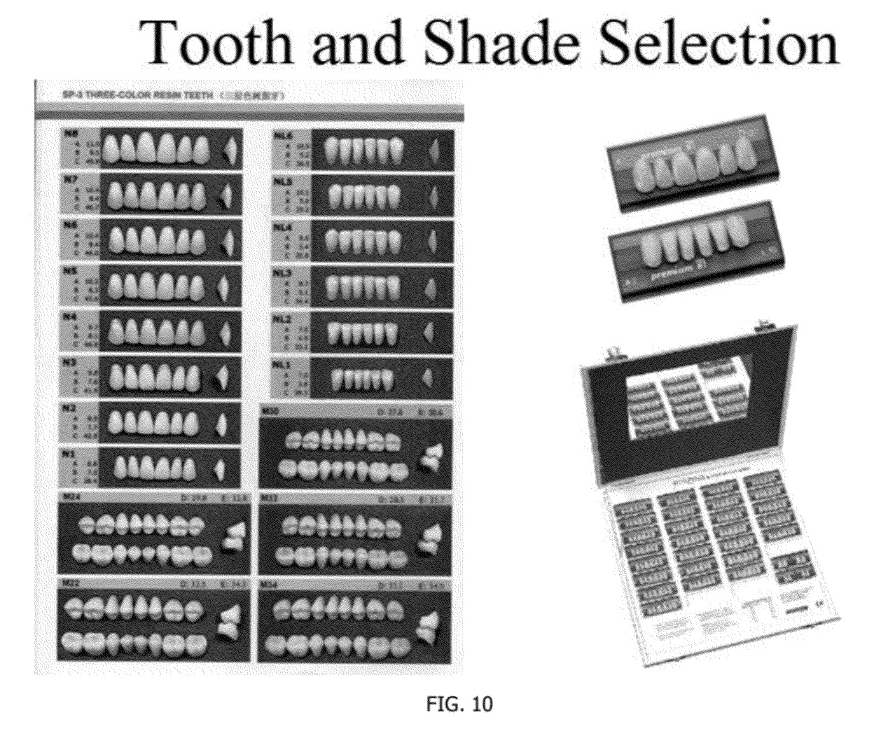

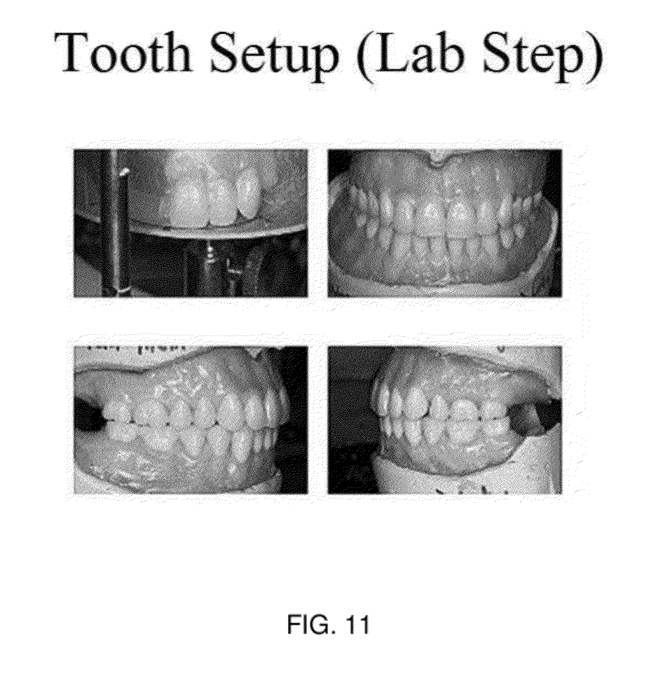

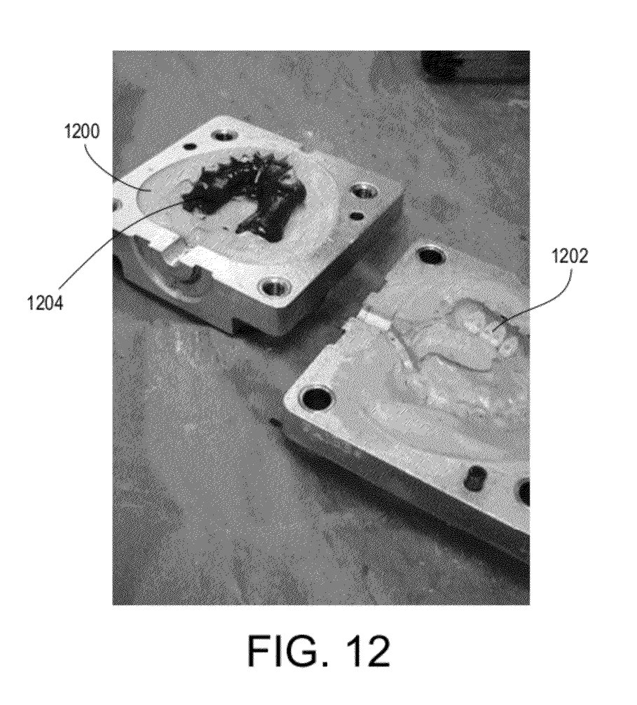

Creating traditional initial and custom trays currently requires two visits 102, 106, as shown in FIG. 1. In one embodiment of the current invention, the dentist creates a custom tray in a single visit using a thermoplastic with optimized material properties for this application. In one embodiment, the thermoplastic is malleable and pliable when heated to a first temperature, wherein the first temperature is comfortable to a patient when the thermoplastic is inserted into his or her mouth. The thermoplastic may thicken or harden to a point where it will retain the shape and features of the patient's mouth upon removal. This hardening may occur at a second temperature lower than the first temperature, wherein the second temperature is reached in a reasonable amount of time (e.g., 1-30 minutes) after the thermoplastic is inserted into the patient's mouth.

The thermoplastic may include a spacer layer on its surface to create an offset (of, e.g., 1 mm) between the thermoplastic and the features of the patient's mouth. The space layer may include a flexible material (e.g., plastic or gauze) that easily separates from the thermoplastic after imprinting. Once the spacer layer is removed, the dentist applies a low-viscosity impression material to the custom tray and again inserts it into the patient's mouth to capture the detail therein.

Rather than preparing a custom impression tray with a thermoplastic preform and a flexible spacer layer, the required spacing between the thermoplastic and patient tissue may be achieved with a small number of discrete offsets. The offsets may be positioned in a small number (such as three) of well-chosen positions on the patient's gum to define the small space needed at the tissue interface. The offsets may be made of wax, plastic, and/or other similar materials.

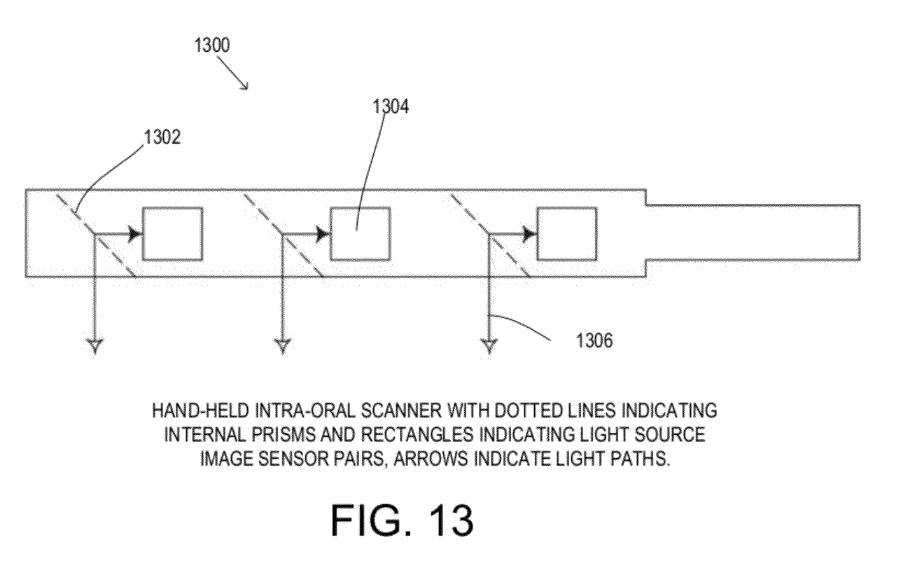

In one embodiment, the physical impression is replaced with an intraoral scan. FIG. 13 shows one embodiment of an intra-oral scanner 1300 having multiple charge-coupled devices. The dashed lines indicate internal prisms 1302, the rectangles indicate light source/image sensor pairs 1304, and the arrows indicate light paths 1306. When scanning using the intra-oral scanner, or alternatively, when scanning a dental impression, the system may feature the use of haptics to allow an operator to physically sense a contact point (or points) corresponding to the scanned impression, or the patient's situation (e.g., mouth tissue), through a force-feedback interface, for use in registration of scan inputs. The haptic device may encode data identifying the location of the device in 3D Cartesian coordinate space. Thus, the location of the device (corresponding to the contact point(s) of the scanned object) is known, and as an operator senses that contact point, he/she can click a stylus button to let the system know to capture that location which can later serve as one or more registration points for scans made relative to the contact point(s).

### Denture Base Plate

In various embodiments, the physical impression is either poured to create a model, which is scanned using a 3D scanner, or scanned directly without a model using an impression scanner. The result of either scan is a 3D virtual master model. A suitable scanner is the REXCAN DS2, manufactured by SOLUTIONIX, of Seoul, Korea. The 3D virtual master model may be created for both fully edentulous patients and those who have some remaining teeth.

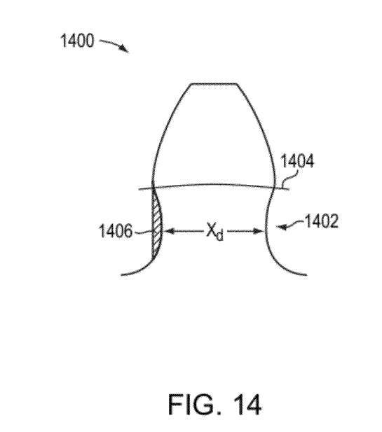

The virtual master model may include undercuts. An undercut is a contour within the patient's oral situation (e.g., gums) that has a smaller diameter or cross-dimension than a portion of the patient's oral situation that protrudes further than the contour. In other words, an undercut is a protrusion with a skinny base and a thick top. FIG. 14 shows a structure 1400 having an undercut 1402, wherein the undercut 1402 has a smaller diameter or cross-dimension X_{d} than a widest point 1404 of the structure 1400.

A virtual denture base plate 600 may be created by drawing a curve on the virtual model to outline the edges of the plate. The amount of undercuts in the virtual base plate 600 may be adjusted on a computer design application to improve the fit of the base plate 600 by selectively adding different amounts of virtual block out wax 1406. For example, a few undercuts may improve the fit of the base plate 600 by allowing it to “grab” onto mating features in the patient's mouth, but too many undercuts may cause the patient to apply excessive force to insert or remove the base plate 600. The design application may allow a user to specify the thickness of the virtual block out wax 1406. The virtual base plate thickness may be set as a preferred parameter. The user may also specify the denture border.

A base plate 600 may be rapid manufactured using either additive (e.g., 3D printing) or subtractive (e.g., milling) fabrication of a biocompatible material. For example, the base plate 600 may be 3D printed using an OBJET EDEN 3D printer with FULLCURE®680, manufactured by Objet Geometries Ltd. of Rehovot, Israel. The base plate 600 may also be milled from acrylic or other appropriate material. The material may be biocompatibly suitable for use in a patient's mouth for an approved, regulated duration (e.g., less than one hour). The rapid-manufactured base plate 600 may be used during the try-in process to test the fit to the patient's mouth. In one embodiment, the rapid-manufactured denture base plate 600 is replaced in the final processing of the denture. In another embodiment, the material is fabricated in a long-term biocompatible material; in this embodiment, the same denture base plate 600 is used during the try-in process and in the final denture. The denture base plate 600 may be a final base plate 600 that is used directly in the mouth as part of a final prosthetic. The denture base plate 600 may also be used in place of a wax denture base as part of a flasking step in standard denture construction. This may reduce distortion that occurs during the flasking step due to shrinkage of the cured acrylic denture base.

The denture base plate 600 may be produced using an apparatus that includes a memory that stores code defining a set of instructions and a processor. The processor executes the instructions to (i) create a model from a scan of a dental stone, dental impression, or a patient situation; (ii) add virtual block-out wax to the model to fill in an undercut portion of the model, a defective portion of the model, or both; and (iii) update the model to incorporate the added virtual block-out wax and virtual relief wax upon a user command, thereby preparing a virtual refractory model onto which a virtual denture base can be built. The processor may also execute the instructions to update the model to incorporate denture border information, as specified by a user.

### Measurements

A traditional wax bite rim 602 may be applied to the denture base plate 600 for a try-in process 114. In this case, measurements may be taken during a dentist visit 110 using traditional techniques. Unlike traditional techniques, however, in embodiments of the current invention, the denture base plate 600 includes undercuts. The presence of undercuts may permit the dentist to test not only occlusion but also fit to the tissue during the try-in process 114. In addition, as described above, using the thermoplastics custom tray and impression, the number of visits can be reduced from five to four.

During the try-in, the dentist may take measurements and perform adjustments. For example the dentist may adjust and mark the wax bite rim 602. The dentist may also adjust horizontal plane vertical dimensions and pitch, yaw, and roll using a wax spatula. Midline and smile line may be marked, and canine-to-canine distance may be measured. In addition, the “freeway” space may be measured when the upper and lower jaws are in a relaxed state (i.e., not in occlusion). A bite impression may be taken by notching the bite rims and then using a bite registration to capture the alignment of the upper jaw to the lower jaw. The dentist may also adjust the denture base using a handpiece to remove material and/or wax to add material, as needed. The dentist specifies the desired tooth cusp angle (e.g., 0, 10, 22, or 33 degrees) and color shade.

The try-in may be sent back to the lab. The lab may scan the wax bite rim 602 and the bite registration in a scanner, such as a REXCAN DS2 scanner, manufactured by SOLUTIONIX, of Seoul, Korea. Special fiducial markers may be placed on the denture base to help with registering the wax bite rim 602 with the model for the denture base. SensAble Dental Lab System (SDLS), manufactured by SensAble Technologies, Inc., of Wilmington, Mass., may determine the horizontal plane, vertical dimensions, midline, and smile lines from the scans. The midline and smile lines may need to be marked with a special marker to improve scanning. These lines are traditionally scored into the wax.

In an alternative embodiment, a specialized digital-measurement device allows the dentist to capture key measurements identified above during the first 102 or second 106 patient visit. This device may include the ability to adjust different dimensions and parameters in the patient's mouth. These measurements may be captured digitally so that they can be sent to the lab electronically. Measurements may also include electronic color, translucency, and shade capture. The digital measurement process is described in greater detail below.

In certain embodiments, denture measurements are obtained by constructing an impression tray (as described above), adding bite rim wax to the bottom of the impression tray, and indicating bite registration relationships using standard melting paddles. When adding the bite rim wax to the impression tray, the wax is added directly over a ridge to an appropriate height. Measurement procedures may also include indexing or marking retro-molar pads, ridge crest, and other anatomic landmarks into the added bite rim wax.

### Virtual Tooth Setup

Given the virtual denture base plate 600 and the measurements, the lab may virtually setup the denture teeth. Physical denture teeth may come in a variety of widths, lengths (e.g., long, medium, short), shapes (e.g., square, square tapering, tapering, and ovoid), and shades. Each denture-tooth product line includes a complete set of mould designs for each permutation of each individual tooth. Furthermore, most major denture teeth vendors offer multiple tooth lines with different price points and aesthetics. In certain embodiments, a manufacturer's line of physical teeth is accompanied by a software library of virtual teeth.

By including the denture-tooth mould designs, styles, and other parameters, along with the patient-specific measurements and the virtual denture base plate 600, the denture teeth may be placed or set digitally instead of physically in wax, as is performed traditionally. For example, given a desired distance between canine teeth of 50 mm, a computer running virtualization software may automatically choose the closest-fitting width anterior teeth using design heuristics such as aligning the anteriors to the midline of the patient's mouth. Setting teeth may include, however, more than just selecting the proper width and shape of the tooth. For example, the teeth may be set along the ridge, taking into account aesthetics and function; they may be set along the occlusal plane (i.e., a plane passing through the occlusal or biting surfaces of the teeth); and upper and lower fossa and cusps may be positioned to provide proper chewing function and forces. In one embodiment, the teeth are set and oriented so that the occlusal facing part of the teeth requires no grinding with a handpiece to accomplish fit. Setting teeth manually can typically take 45-60 minutes for skilled lab technician to set a single arch; using embodiments of the present invention, this time may be reduced to, e.g., less than five minutes.

Inputs to the virtual tooth setup may include information from the impression, from a digital measuring device, from the color, shade, or transparency of existing natural teeth, from virtual or real articulation, and from information from the patient (e.g., age, gender, or face shape). For example, the design application may use: (i) the cusp angle of the denture teeth selected by the dentist; (ii) knowledge of teeth balancing as a virtual articulator is moved throughout an excursive range of motion; (iii) physics-based interactions between neighboring or opposing teeth where collisions and interference are calculated; (iv) virtualized standard manual procedures; and (v) virtual embodiments of dental lab rules of thumb, such as matching of marginal ridge heights. The design application may also use measurements determined by a virtual articulator to readjust positions of the virtual denture teeth and/or to place each of said virtual denture teeth in relation to said virtual denture base plate 600. In one embodiment, the virtual tooth setup permits a user to switch between different brands or manufacturers of denture teeth, even for a completed virtual set-up, to determine, for example, if a set of denture teeth from one manufacturer fits better than from a second manufacturer.

Using the impression scan, bite rim scans, curves, and landmarks identified above on the master model, a lab technician may use SDLS for virtual tooth setup. A complete set of CAD mold models of physical denture teeth may be included in the system. Such models may be licensed from major denture tooth vendors, such as VITA, HERAEUS, IVOCLAR, and/or DENTSPLY. The system may use predefined rules to set the teeth, such as those published by PTC. A “slider” or macro may be included to change the look from “soft” to “bold,” which can rotate the canines and make other adjustments according to predefined rules. The system may place the teeth virtually to optimize occlusion for the entire set of teeth. In physical denture preparation, the physical denture teeth may be held in place using a wax or thermoplastic, in which case a thin user settable gap may be required. The denture teeth may be held in place by wax along the sides of the teeth, and/or in contact with the bottoms of the denture base.

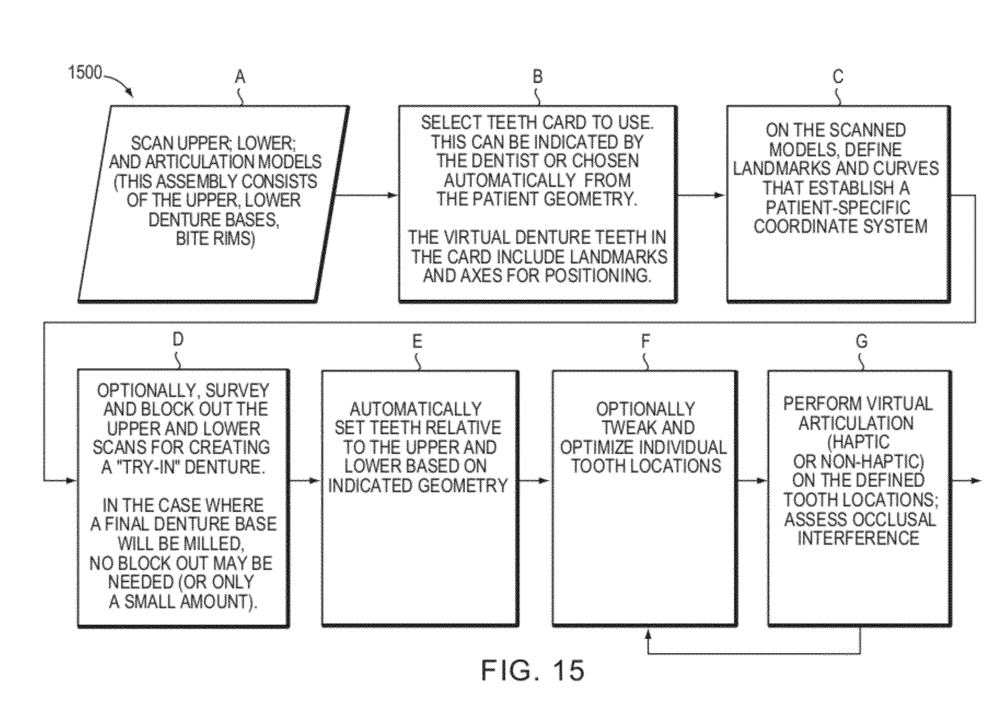

Referring to FIG. 15, in certain embodiments, a method 1500 for setting denture teeth includes a series of steps (steps A through G). The method 1500 includes scanning (step A) upper teeth/jaw, lower teeth/jaw, and an articulation model. Next, a tooth card library (e.g., a plurality of virtual teeth) to be used is selected (step B). The individual tooth models in the card library are enhanced with particular landmarks that are further described herein. The virtual teeth may be represented by voxels, or by triangulated 3D surface meshes. Curves and landmarks are also defined (step C) on the scanned upper, lower, and articulation models. As an optional step, the upper and lower scans may be surveyed and blocked out (step D) for creating a try-in denture. In a case where a final denture base will be milled, no block out or a small amount of block out may be needed. The library teeth are then automatically set (step E) relative to the upper and lower scanned models using the curves and landmarks. At this point, the teeth positions can be manually tweaked and optimized (step F). As a further optional step, virtual articulation (e.g., using a haptic device or non-haptic device) can be performed (step G) to assess the occlusal interference of the teeth. If necessary, teeth positions can be adjusted and interference can be reassessed by performing (step G) virtual articulation.

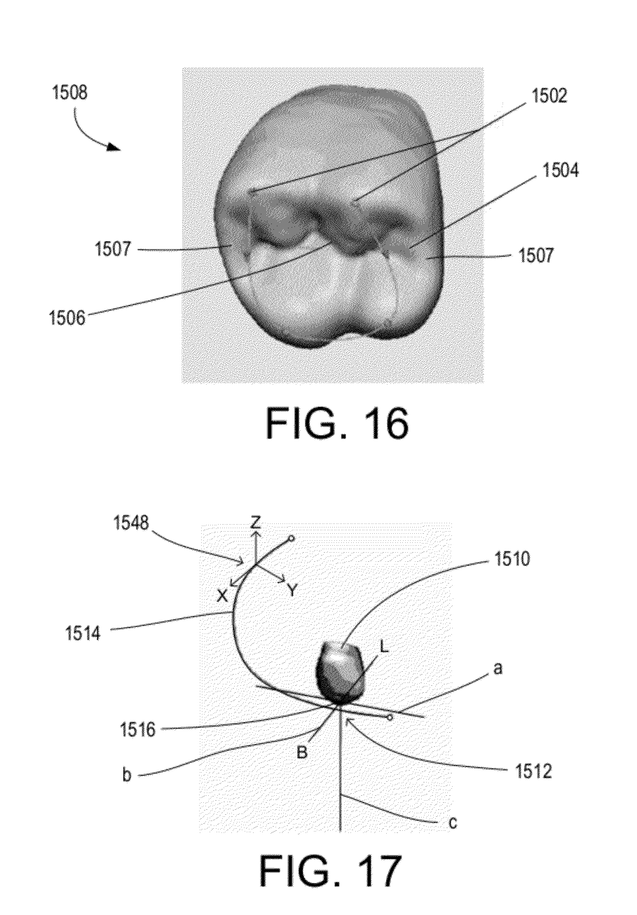

As mentioned, the virtual teeth in the card library may include pre-defined landmarks. Referring to FIG. 16, the landmarks may include or be associated with, for example, cusps 1502, fossae 1504, grooves 1506, and marginal ridges 1507 on the surface of a molar 1508. Typically, for step B, the landmarks on the teeth are only created once for each tooth in a tooth library. In contrast, the landmarks for bite impression scans (e.g., the scans of the upper jaw, lower jaw, and articulation model from step C) may need to be created for each new job and each new patient-specific set of scans.

Referring to FIG. 17, in certain embodiments, each tooth in the card library, such as a canine tooth 1510, has its own local coordinate system 1512, with three ortho-normal axes. As depicted, axis a indicates tooth direction. In one embodiment, axis a is placed automatically so that it is parallel with or tangent to a bite rim curve 1514, which includes straight line segments joining retro-molar pads to canine regions on each side of the lower jaw. For example, axis a may be parallel to the bite rim curve 1514 at the given tooth position. In one embodiment, axis a is parallel to a line drawn tangent to the bite rim curve 1514 at a point on the bite rim curve 1514 that is closest to the tooth 1510 or an origin for the tooth 1510. Axis a may also be referred to as a tooth direction axis. In general, axis a is oriented toward an adjacent tooth on the same side (i.e., upper or lower) of the mouth. Axis b, also referred to as a buccal-lingual axis, varies gradually, from tooth to tooth, along the bite rim curve. Axis b is typically perpendicular to the bite rim curve 1514 and an occlusal plane normal (i.e., a vector normal to the occlusal plane), and is used to position teeth with respect to the tongue. In general, axis b is oriented towards the tongue. Axis c, also referred to as the long axis, may pass through the tip of the tooth 1510 (e.g., for anterior teeth), or it may pass through a midpoint located in a central groove of the tooth 1510 (e.g., for posterior teeth). Axis c may also pass through the root of the tooth 1510. Axis c may be used for vertical positioning as well as controlling the slant of the tooth 1510. In certain embodiments, when a virtual tooth is positioned with respect to oral scans of patient, axis a, axis b, and/or axis c are substantially matched to a shape of the oral scans, such as a bite rim wax curve and a lower jaw scan.

Axis a, b, and/or c may be defined manually by a user, found automatically (e.g., according to a shape of the tooth), and/or defined by the tooth manufacturer as part of a tooth's specified design. Manually defining the position and orientation of axis a, b, or c may include assessing a desired position for the tooth 1510 in the mouth. For example, in general, axis b is oriented inwards, towards the tongue, and axis c is oriented along a length of the tooth (e.g., in a direction of biting or along a vector associated with a biting force). In one embodiment, a tooth library (e.g., a file containing virtual models of one or more teeth) is provided that includes defined locations and orientations for axes a, b, and c for each tooth.

Each tooth, in addition to having the local coordinate system 1512, also has a well-defined origin 1516, which may be referred to as a pivot point 1516. The pivot point 1516 may be located at any location on, adjacent to, or within the tooth 1510. As depicted in FIG. 17, in one embodiment, the pivot point 1516 is located at a tip of the tooth 1510.

In certain embodiments, cusp 1502, groove 1506, and/or sulcus locations are defined, especially for posterior teeth. In a typical set of denture teeth, the ridges (e.g., cusps 1502) and valleys (e.g., grooves 1506) of the posterior (virtual) teeth are designed such that the lower teeth fit together with the opposing upper teeth in proper occlusion (i.e., with cusps 1502 of one tooth fitting into grooves 1506 of the opposing tooth). This design is provided by denture teeth vendors, such as VITA of Brea, Calif., HERAEUS of South Bend, Ind., and DENTSPLY of Tulsa, Okla. When using a computer system to set denture teeth, however, it is useful to create landmarks per virtual tooth that make these locations explicit. The landmarks can then be used to automatically fit the opposing teeth. The landmark positions may be defined manually by selecting points on the provided library teeth (e.g., with a mouse cursor), or automatically by analyzing the geometry file, or through template fitting. For example, in one embodiment, the determination of landmark positions may involve searching for the cusp 1502 and groove 1506 locations on a tooth. In certain embodiments, landmarks that may be selected automatically or manually include: the tooth direction axis (axis a), the buccal-lingual axis (axis b), the long axis (axis c), a designated pivot point 1516, a marginal ridge 1507, and designated cusps 1502, fossae 1504, and grooves 1506. Some tooth setting implementations may use all of these landmarks, others may use only some of them. In one embodiment, because user selected landmarks may be inaccurate, methods are employed to reposition these landmarks slightly during their use. For example a cusp point marked on a tooth surface may be used as a seed point for locating a patch of surrounding tooth surface. Methods, such as distance calculations, that employ the entire patch are protected from such slight in-accuracy of the initial cusp position. As discussed above, in certain embodiments, these landmarks are provided by a tooth manufacturer as part of a specified design.

At step C, landmarks and curves are defined on the 3D scan models. In one embodiment, to make the problem of setting the virtual teeth more tractable, a set of landmark points and curves, in addition to those defined for the teeth, are defined on the scan of the upper jaw, lower jaw, and on the articulation model that includes the bite rim structure. As mentioned, these landmarks can either be derived automatically from the registered 3D scans, or they can be derived and placed manually. Manual placement may involve the use of a 3D pointing device to indicate positions on a surface in 3D. The 3D pointing device may be, for example, a haptic input device and/or a mouse cursor that remains snapped to the surface. With such a device the user can point to and identify places on the 3D scans. Landmarks and curves on the 3D scan models that may be useful include: a midline, canine positions, retro-molar pad positions, hamular notch positions, bite rim shape, and curves that mark the crest of the lower and upper jaw ridges.

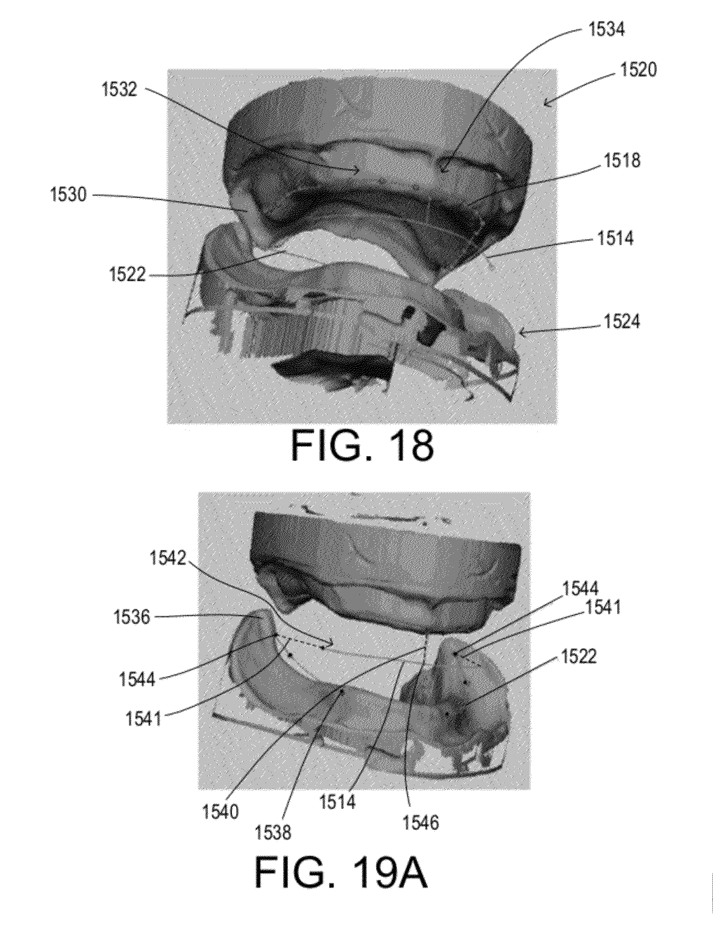

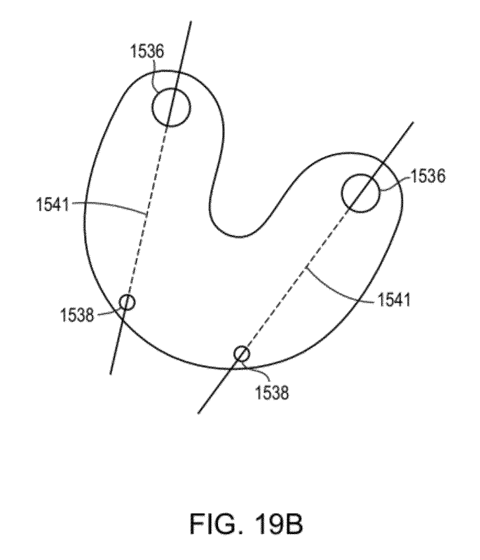

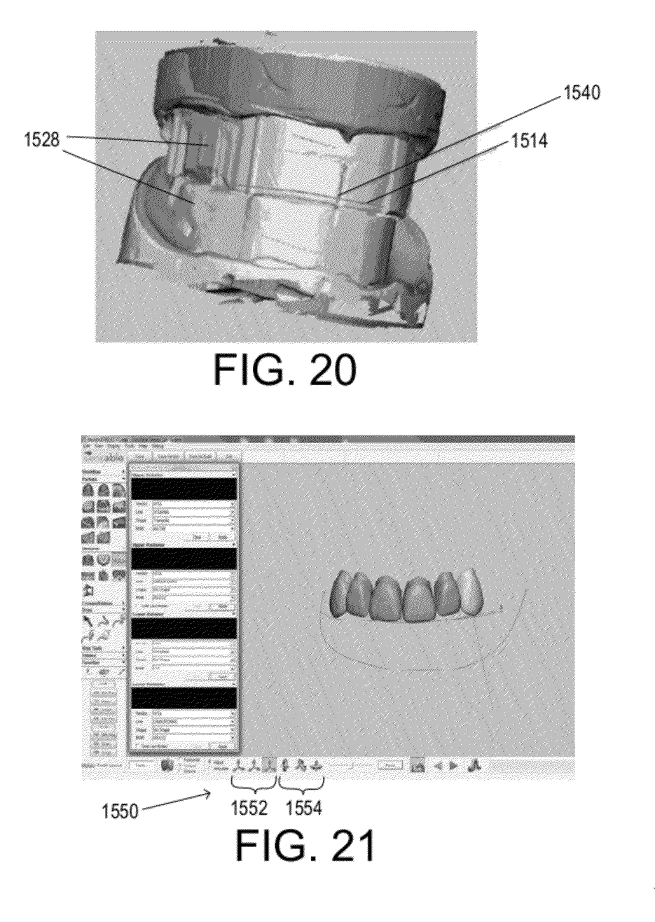

FIGS. 18 through 20 depict manually selected points or landmarks on the scans, joined together visually by curves, in accordance with an embodiment of the invention. In particular, the user might draw three such “curves”: an upper jaw curve 1518 on the 3D scan of the upper jaw 1520, a lower jaw curve 1522 on the 3D scan of the lower jaw 1524, and a bite rim curve 1514 on the 3D scan of the bite registration wax 1528. In one embodiment, the upper jaw curve 1518 matches a shape of the upper jaw 1520, beginning on one side at a hamular notch 1530, moving to the front canine region 1532 and anterior tooth region 1534, then extending back to the hamular notch 1530 on the other side. The lower jaw curve 1522 typically includes a position ⅔ of the way up a retro-molar pad 1536, and a lower canine position 1538 on the lower jaw 1524. It is recommended that at least these four points or landmarks be defined for the lower jaw curve 1522. The bite rim curve 1514 or bite registration wax curve 1514 follows the shape of the anterior portion of the bite rim wax 1528, including a landmark for a midpoint 1540. The bite rim curve 1514 includes extensions 1541, which may be linear, on either side, that extend towards the posterior at least as far as the approximate future position of the first premolar. Referring to FIGS. 19a and 19b, in certain embodiments, the lower canine region 1538 is marked to obtain the extensions 1541 (i.e., straight line segments) between the retro-molar pads 1536 and the lower canine region 1538, on each side of the lower jaw.

Referring to FIG. 19a, the landmarks described above may be used to define the position of the occlusal plane. In one embodiment, an occlusal plane 1542 passes through lower posterior points 1544, located ⅔ of the way up the retro-molar pads 1536, and an anterior point 1546, defined by the intersection of the midline 1540 and the bite rim curve 1514. The bite rim curve 1514 may lie in the occlusal plane 1542, or the bite rim curve 1514 may be substantially close to and substantially parallel with the occlusal plane 1542.

In certain embodiments, the bite rim curve 1514 is directed positively from the patient's right towards the patient's left. In one embodiment, the bite rim curve 1514 lies in the occlusal plane and helps to establish a collection of adapted coordinate systems for different positions on the jaw that are used for tooth placement, as described below for steps E and F. As described above, in one embodiment, the bite rim curve 1514 is determined from landmarks on the bite registration wax 1528 and the positions of the retro-molar pads 1536. As described above, the occlusal plane 1542 may be set manually by the user or found automatically using the retro-molar pad and rim midpoint features. During virtual tooth placement, the tooth direction axis may be matched to the direction of the bite rim curve 1514 where the tooth is placed. The tooth direction, especially for posterior teeth, may be matched to the extensions 1541 (i.e., straight line segments joining the retro-molar pads 1536 to the canine regions). In certain embodiments, the bite rim curve 1514 is also referred to as a jaw direction curve, which may be parallel with the line(s) joining the retro-molar pads 1536 and the canine regions in the posterior portion.

In certain embodiments, the methods provided herein utilize user-selected landmarks on 3D bite impression scans 1528. In one embodiment, these methods utilize particular user-defined landmarks on 3D bite impression scans 1528 for: midline 1540, canine positions, retro-molar pad positions, hamular notch positions, and bite rim shape.

At step E, the method includes automatically setting teeth based on the defined landmarks, curves, and occlusion (e.g., tooth shapes) for the teeth and scanned models. While there are several sequences possible for setting teeth, in one embodiment, the exact tooth placement is determined by a series of steps that utilizes the embedded tooth landmarks (from step B) and the defined landmark points and curves on the scans (from step C). These embedded tooth landmarks and the defined landmark points and curves from the scans are used in conjunction with analyzing the collisions between teeth via a distance field technique, for speed.

Referring again to FIG. 17, in one embodiment, the position of the tooth 1510 is determined according to its local coordinate system 1512 and a jaw coordinate system 1548, located on the bite rim curve 1514. At any given point along the bite rim curve 1514, the jaw coordinate system 1548 includes an x-axis that is tangent to the bite rim curve 1514, a y-axis that is perpendicular to the bite rim curve 1514 and lies within the occlusal plane 1542, and a z-axis that is perpendicular to the bite rim curve 1514 and the occlusal plane 1542. In one embodiment, the tooth 1510 is positioned by aligning the tooth direction axis (axis a) of the tooth 1510 with the bite rim curve 1514. In this way, the tooth position and orientation may be constrained with respect to the bite rim curve 1514. For example, lateral adjustments of the tooth position may require the tooth 1510 to follow the path of the bite rim curve 1514. As the tooth 1510 is translated lateral, the tooth may rotate as axis a is constrained to be parallel with the bite rim curve 1514 at the give tooth position. For example, the tooth 1510 may be placed so that axis a is aligned or parallel with the x-axis of the jaw coordinate system 1548 at the tooth location. Likewise, the tooth 1510 may be placed so that axis b is aligned with the y-axis and/or axis c is aligned with the z-axis.

The positioning of multiple teeth along the bite rim curve may be achieved by ensuring the spacing (e.g., interproximal space) between adjacent teeth is within a certain specified range or tolerance. The method may include an iterative scheme that optimizes this lateral spacing to avoid tooth overlap or excessive gaps. Positioning of each tooth with respect to the tongue is achieved by moving the tooth along its buccal-lingual axis (axis b). Similarly, vertical positioning of each tooth is achieved by moving the tooth along its long axis (i.e., axis c). In one embodiment, during automatic positioning of the teeth, axes b and c are perpendicular to the bite rim curve at the given tooth location. Axis b may lie within or be parallel to the occlusal plane 1542, and axis c may be perpendicular to the occlusal plane 1542.

Automatic positioning of one or more teeth may include measuring gaps or distances between teeth and moving the teeth to adjust these distances. For example, the automatic method may include measuring lateral (e.g., along the tooth direction axis) gaps and overlaps between adjacent teeth, and adjusting lateral positions of the teeth until the gaps and overlaps are desirable. Likewise, the automatic method may include measuring gaps and overlaps between opposing teeth and adjusting vertical positions of the teeth until the occlusion is proper (e.g., a cusp of one tooth fits into a groove of an opposite tooth). In addition, the automatic method may include adjusting the position or orientation of one or more teeth so that the marginal ridges 1507 of adjacent teeth are aligned or transition smoothly from tooth to tooth. For example, two adjacent teeth may be translated until their marginal ridges 1507 are matched in height above the occlusal plane 1542. These techniques may be iterative, with measurements and adjustments being made until a tolerance is satisfied.

In certain embodiments, the long axis (axis c) of a tooth is adjusted so that it is not normal to the occlusal plane 1542. For example, to approximate natural teeth, it may be desirable for the long axis of an anterior tooth to be angled so the long axis passes near or adjacent to the bite rim curve 1514 and the upper jaw curve 1518. In one embodiment, a tooth is positioned so that the tooth long axis is perpendicular to the bite rim curve 1514 and angled to (i) make contact with the lips on the tooth's outer surface (e.g., for an anterior tooth), or (ii) be directed towards the lower jaw (e.g., for a posterior tooth). Angling the long axis in this manner may cause the buccal-lingual axis to become angled with respect to the occlusal plane 1542.

At step F, individual tooth positions are manually adjusted based on the local coordinate system 1512 and/or the jaw coordinate system 1548, described above. The tooth landmarks and curves (from step B) and the jaw landmarks and curves drawn on the scan models (from step C) create these well-defined and dentally significant coordinate systems (i.e., the local coordinate system 1512 and the jaw coordinate system 1548), which may be used for automated setup (e.g., in step E) and intuitive manual adjustments. The tooth direction and/or jaw direction may also be referred to as a mesial-distal direction.

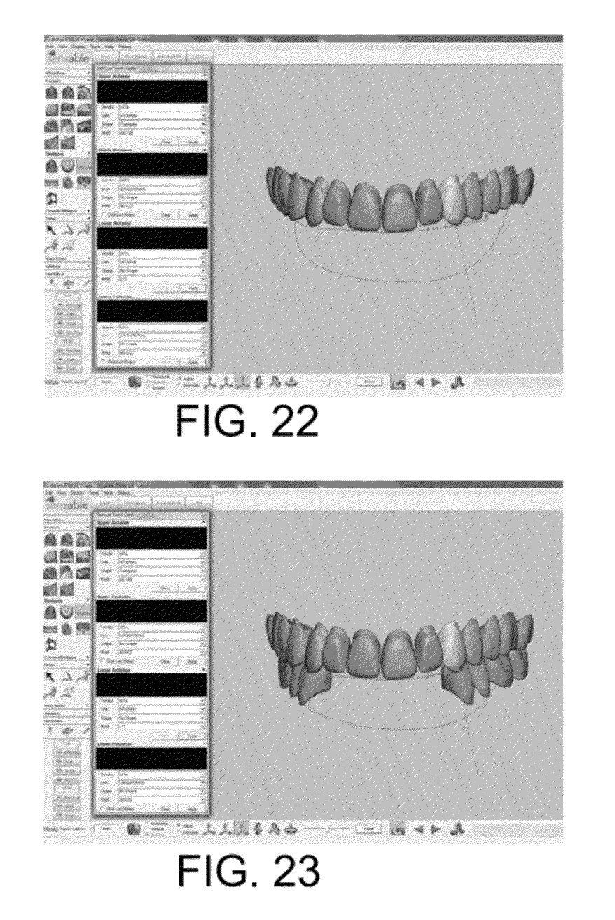

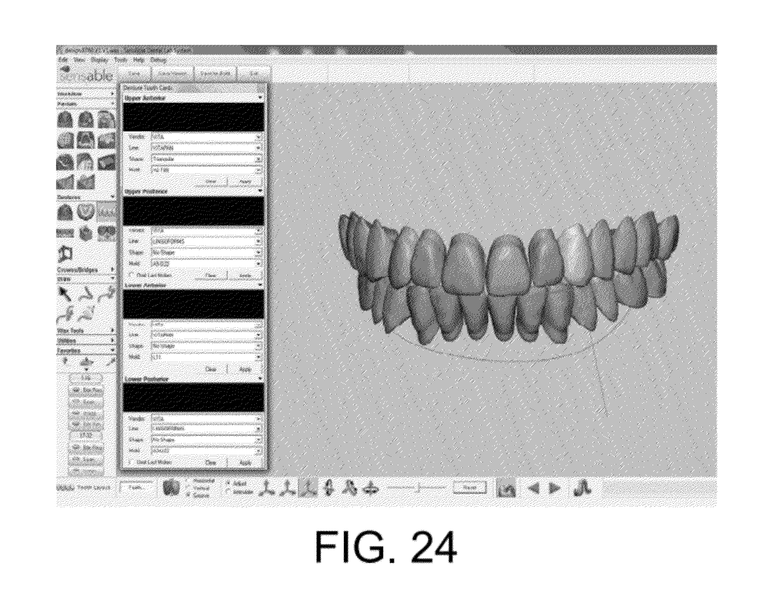

FIGS. 21-24 depict screenshots of a computerized implementation of the methods described above, in accordance with one embodiment of the present invention. The depicted embodiment includes six controls 1550, one for each of six degrees of freedom, for adjusting a position and/or orientation of one or more teeth. These controls 1550 allow one or more teeth to be translated and/or rotated with respect to their local coordinate systems 1512 and/or the jaw coordinate system 1548. For example, referring to FIG. 21, the first three controls are translation controls 1552, which translate one or more teeth along one or more axes (e.g., axis a, b, or c). The last three controls are rotation controls 1554 which rotate one or more teeth about the pivot point 1516 and one or more axes (e.g., axis a, b, or c). The translation controls 1552 and rotation controls 1554 may be buttons that a user can activate or click with a user input device, such as a mouse. The controls 1552, 1554 are also be referred to herein as a graphical user interface (GUI).

As depicted in FIGS. 21-24, teeth may be set in the following sequence: (1) the upper anterior teeth, (2) the upper posterior teeth, (3) the lower posterior teeth, and (4) the lower anterior teeth. Other sequences are contemplated. In certain embodiments, automatic tooth placement begins by placing the teeth in accordance with standard denture manufacturing practice. Gaps, overlaps, and/or mis-matched ridge heights may then be adjusted or corrected to optimize the fit to a particular patient's jaw scans.

In certain embodiments, step F includes adjusting the position of teeth to achieve the desired occlusion between opposing teeth and relative height between adjacent teeth. For example, automatic and/or manual adjustments may include rotating or twisting a tooth (e.g., using the controls 1550) so that the marginal ridges of adjacent teeth are aligned, to achieve a smooth transition from tooth to tooth, across the interproximal space. Another goal is to fit the cusps of one tooth into the grooves of its opposing tooth. When adjusting teeth, more than one tooth may be selected at a time, thereby allowing multiple teeth to be translated and/or rotated at the same time.

In one embodiment, the computerized implementation of the method (e.g., a system for performing the method) allows a user to efficiently assess and adjust interferences and/or occlusion between teeth. For example, an integrated virtual articulator, such as the virtual articulator described below, may be used to simulate biting between the upper and lower teeth. As part of a biting simulation, the system calculates interferences and assesses occlusion between the upper and lower teeth. In one embodiment, interferences and/or occlusion are displayed to the user in multiple colors. For example, regions corresponding to undesirable or excessive interference or occlusion may be colored red, and regions with acceptable interference or occlusion may be colored green. As the user adjusts teeth positions, the colors may be updated, thereby allowing the user to arrive at desired tooth positions more quickly and efficiently.

By utilizing the local coordinate systems 1512 for each tooth, the jaw coordinate system 1548, and/or the bite rim curve 1514, the process of automatically setting and adjusting teeth is advantageously performed in dentally significant directions. For example, when a tooth is translated in the direction of axis a, the tooth may moved along the jaw or bite rim. Similarly, when a tooth is translated in the direction of axis b, the tooth is moved with respect to the tongue. Both of these directions, along with the tooth long axis direction, are dentally significant in that they correspond to directions dental practitioners and denture manufactures intuitively consider when preparing dentures or when assessing and adjusting tooth positions.

In another embodiment, a tooth position macro is provided that automatically adjusts the position and/or orientation of specific teeth in a pre-defined manner. The tooth position macro may be used, for example, to adjust the exposed length of canine teeth according to gender, or to achieve an attractive gap between the two top front teeth. In other embodiments, the macro is used to achieve a characteristic look (e.g., a tucked position of the lateral incisors) associated with a particular brand of dentures. By running the macro, the tooth positions and/or orientations are automatically adjusted to achieve the desired effect. In one embodiment, the macro is created by recording the steps input by a user into a computer to move and/or rotate specific teeth to achieve the effect. Once the steps have been recorded into the macro, the macro can later be rerun and applied to one or more sets of teeth. For example, software code or a module may be configured to permit recording a collection of user activities (i.e., a macro) and allowing these activities to be repeated automatically (i.e., playback).

In another embodiment, teeth on one side (i.e., the upper teeth or lower teeth) are set independently of the teeth on the other side. For example, the upper teeth may be set according to the procedures described above and, once the upper teeth positions have been finalized, the lower teeth may be introduced and positioned relative to the upper teeth.

In certain embodiments, the methods for setting virtual teeth, described above, are performed using an apparatus that includes a memory for storing a code defining a set of instructions, and a processor for executing the set of instructions. The code includes a virtual tooth placement module configured to perform the method steps, described above.

### Virtual Articulation

Once the teeth have been set in centric relation or centric occlusion (as provided by the bite relation from of the dentist), they may be tested and adjusted in light of excursive movements (i.e., lateral and protrusive movements). Use of a physical articulator, as performed in the prior art, is a time-consuming process because each tooth must be adjusted individually, tested, and further adjusted to ensure proper occlusion. In one embodiment, a virtual articulator is used to test excursive movements of a virtual model. With this approach, virtual teeth may be adjusted automatically to provide optimal balanced occlusion. Manual adjustments may also be made. If a gothic arch (or an equivalent physical or electronic measuring device) is used to capture the excursive movements, these measurements may be used as input for the virtual articulation.

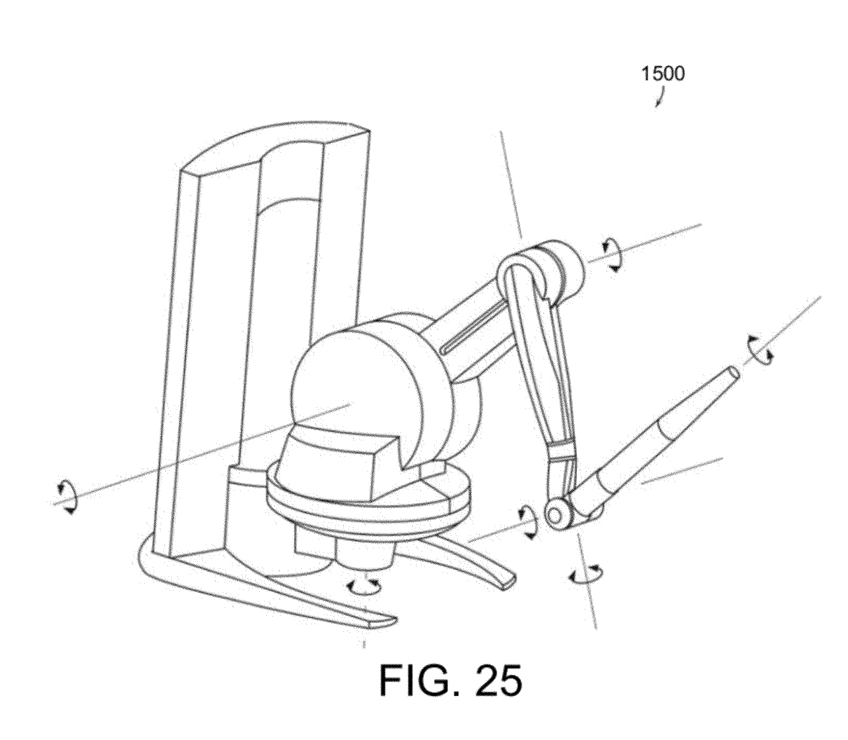

In one embodiment, the virtual articulator is a haptic virtual articulator, allowing the user to feel the contact between teeth. FIG. 25 illustrates one embodiment of a haptic device 1500. The haptic device 1500 is an exemplary three-degree-of-freedom force-reflecting haptic interface (3 powered DOFs, 3 unpowered DOFs) that can be used in accordance with one embodiment of the invention. The interface can be used by a user to provide input to a device, such as a computer, and can be used to provide force feedback from the computer to the user. The six degrees of freedom of interface are independent. Further information on haptic devices and the use thereof for dental procedures is provided in U.S. application Ser. No. 12/321,766, filed on Jan. 23, 2009, and U.S. application Ser. No. 12/692,459, filed on Jan. 22, 2010, which is hereby incorporated by reference herein in its entirety.

The virtual articulator may simulate the action of a dental articulator (e.g., up/down, protrusive, and lateral movement). A user may control the position of the upper teeth through the user interface (e.g., a haptic interface). The virtual articulator system may detect and analyze body-to-body collisions (e.g., collisions between the upper teeth and lower teeth), and may calculate the rigid-body response force thereof (and transmit the response force to a user via haptic feedback). A design application used with the virtual articulator system is able to show the magnitude of the collision forces (or depth of interpenetration) using, for example, different colors to highlight the locations where the force is the highest. In addition, the virtual articulator is adjustable in the standard ways, including the inclination of the condylar guidance, the Bennett angle, and the inclination of the incisal guidance. The virtual articulator is also able to accept standard face bow measurements from a specific patient. Further, the virtual articulator system allows for grinding of the virtual teeth in, for example, a crown and bridge situation, or as the final step in equilibrating dentures. Using the virtual articulator to perform occlusion analysis may improve the final teeth placements so that the final try-in requires minimal adjustments chairside.

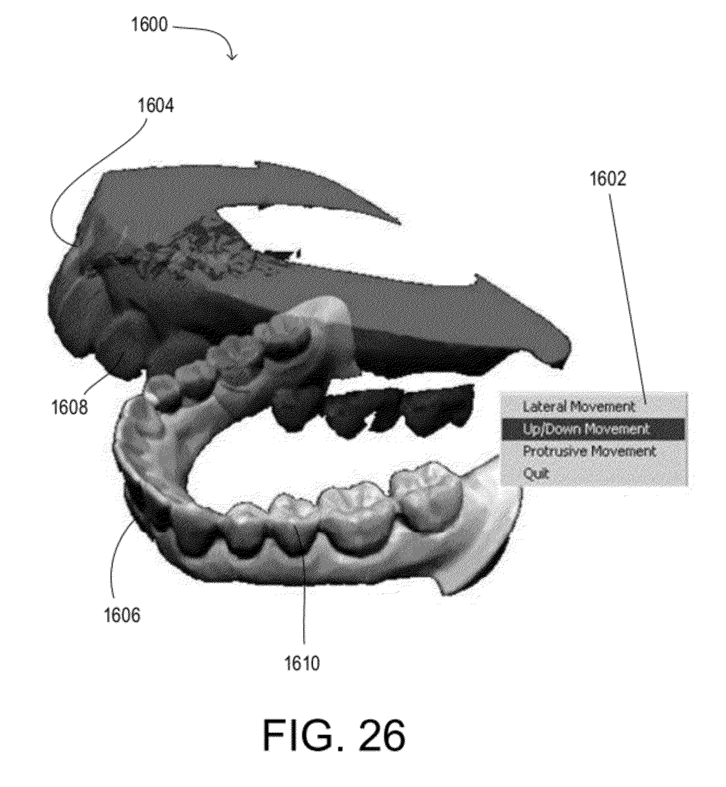

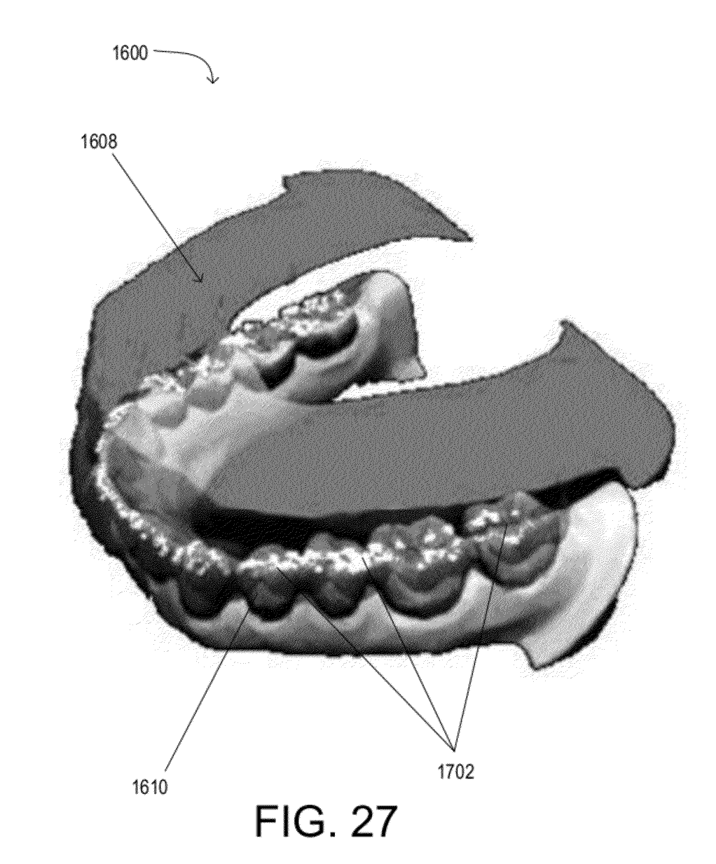

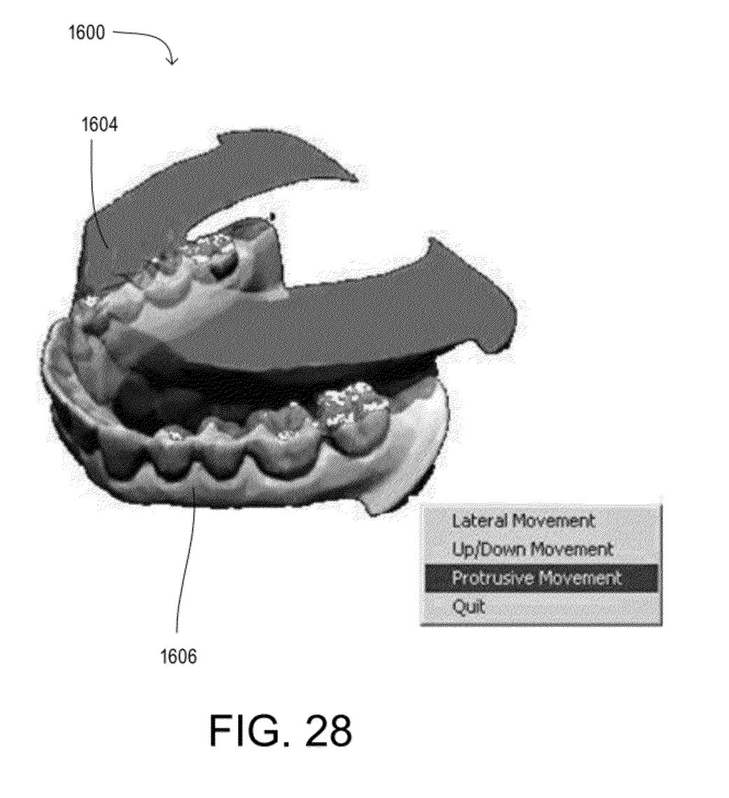

FIG. 26 illustrates one embodiment of a virtual articulator 1600 with a menu 1602 for choosing a type of movement (lateral, up/down, or protrusive). The virtual articulator 1600 includes an upper jaw 1604, a lower jaw 1606, virtual upper teeth 1608, and virtual lower teeth 1610. FIG. 27 illustrates collision detection, wherein colliding points 1702 between upper teeth 1608 and lower teeth 1610 are highlighted. FIG. 28 illustrates selection and performance of protrusive motion.

### Digitally Fabricated Gingival Structure

Once the teeth have been virtually set and adjusted with the virtual articulator, the gums may be modeled digitally to create a natural-looking denture in a process known as festooning. Festooning tools (semi-automatic) may be used to digitally sculpt the bite rim. Certain initial measurements of the papilla may be set according to rules, such as extending the papilla to the contact points of the teeth (usually at the height of contour). Additionally each tooth in a tooth library can be extended to include a “gingival curve” that establishes the initial gum line.

The custom, patient-specific bite rim may then be fabricated from the 3D digital model using either additive or subtractive fabrication, as described above. For example, the bite rim may be manufactured using a rapid prototyping machine, such as an OBJET 3D printer using FULLCURE®680 or 720, manufactured by Objet Geometries Ltd. of Rehovot, Israel. The bite rim may also be milled from plastic, wax, and/or other suitable materials. Holes in the digitally fabricated bite rim match the moulds and orientation of the desired denture teeth, thus allowing a lab technician to simply insert the physical denture teeth into holes for proper orientation and placement. A small gap may be built-in to the holes, and the gap may be used to hold the teeth in the bite rim with a wax or thermoplastic.

In some embodiments, the placed teeth are too long and extend beyond the bottom of the denture base (i.e., potentially into the patient's gums). In these cases, the lab tech may align the teeth with the bottom surface of the denture base (using, e.g., a handpiece to grind away the excess). For example, the denture teeth may be cut back using a printed jig that firmly holds the teeth in place. The lab tech may use a handpiece to grind down the bottoms of the teeth, following a custom guide that is an integral part of the printed jig. This may require a separate jig block for cutting back the teeth, or it may include a jig that fits over the printed bite rim to provide additional support during the cut back process. This technique may allow the lab tech to complete the cut back process for the entire denture in a very short amount of time (e.g., less than one minute); prior-art techniques may take much longer because each tooth must be cut back individually. The bite rim and base plate may be manufactured with notches or pins to align the two components back together once they have been manufactured.

### Portal-Based Supply Chain Ordering

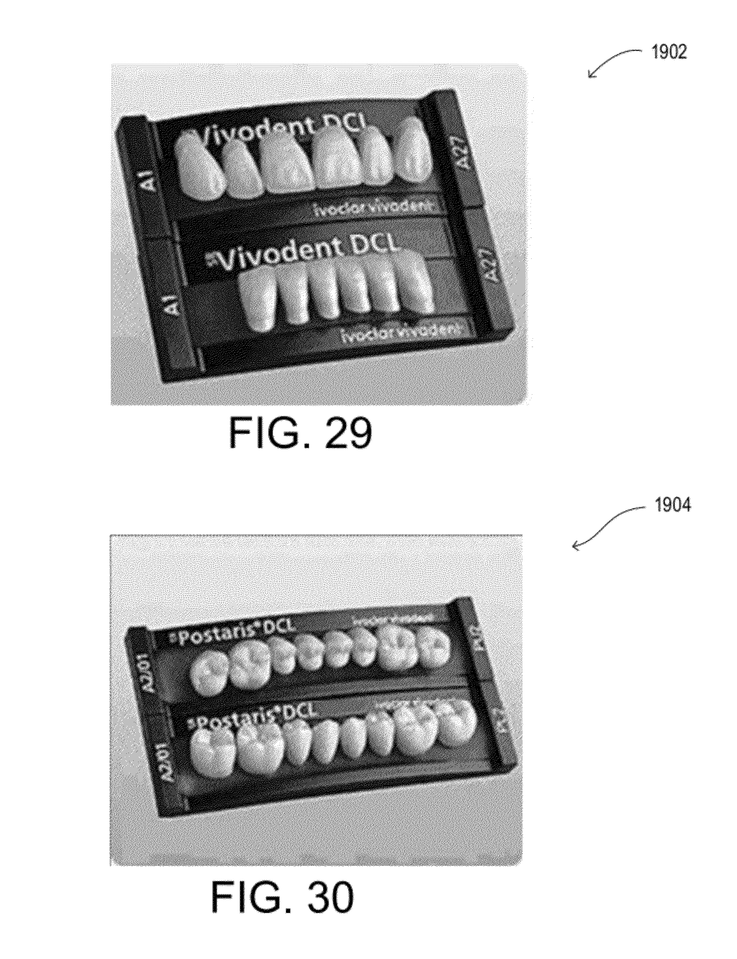

In prior-art techniques, denture teeth are ordered on anterior cards 1902 or posterior cards 1904 as shown in FIGS. 29 and 30. A lab may pick and choose the teeth they need for a particular patient. Typical business practices of denture teeth vendors include placing inventory at labs on consignment and taking periodic inventory to determine actual usage and to replenish the stock.

In embodiments of the current invention, the system automatically picks the right tooth mould. The system may also, through an e-commerce portal, automatically order the teeth needed for the specific case for, e.g., next-day delivery. The printed base plate and bite rims may also be ready the next day so that the lab can complete preparation of the try-in by mounting the teeth to the base plate and bite rim. For partial dentures, in which only a subset of the complete set of teeth are needed, the system may order only those teeth needed for that case. For example, if a partial denture requires one anterior tooth and two posterior teeth, traditionally the lab needs to order or use an anterior and a posterior card, pick off the three needed teeth, and wait for their denture tooth vendor to replenish the used inventory periodically.

Portal ordering simplifies ordering for the lab and may eliminate or reduce all inventory of denture teeth. Millions of dollars of denture teeth inventory are currently locked up in labs across the world. Reducing or eliminating this inventory will also benefit the denture-teeth vendors' balance sheets and expenses for managing the consigned inventory.

### Perfect Try-in

A “perfect try-in” may be created in accordance with the above-described techniques and includes a biocompatible denture base plate, a digitally fabricated gingival structure or “bite rim” (attached to, or manufactured in conjunction with, the denture base plate), and physical denture teeth (held in place with wax or a thermoplastic material). Unlike traditional methods, the dentist may test the fit and adjust the try-in on both the tissue side and the occlusion. The dentist may grind down areas of the denture base plate if the patient has a bone spur or an area of discomfort. The dentist may adjust any of the teeth by softening and resetting teeth into the wax or thermoplastic used to hold the denture teeth in place. Additional wax or thermoplastic material may be added during the adjustment, as necessary. The dentist may also provide instructions to the lab to make other adjustments, such as reducing the left side of the horizontal plane by, for example, 1 mm.

After the dentist has made adjustments, the bite rim may be scanned using, for example, a 3D scanner to redesign or further adjust the placement of the teeth. The scanning may be performed at a dental lab. A goal of the perfect try-in is to minimize “processing” (e.g., flasking) error at the dental lab.

If major adjustments to the bite rim are needed, the lab may remove and/or add material. For example, the lab may remove material from the bite rim using a handpiece. The lab may add material to the bite rim using wax. In severe cases, the lab may choose to redesign the bite rim and reprint the part to be affixed to the denture plate.

### Final Processing

Once the perfect try-in has been adjusted and approved by the dentist, it may be sent to the lab for final processing. If a temporary denture base plate or bite rim has been used, it may be replaced in a flasking process with a traditional acrylic or plastic apparatus, in which the denture is surrounded by a plaster material and placed in flask that can be opened. If the denture was modeled in wax, the wax is melted away, leaving a cavity with the teeth held in place in the plaster. If a temporary biocompatible material was used in the try-in, the material pattern may be physically removed and discarded, leaving a cavity with the teeth held in place in the plaster. Acrylic or plastic is then injected into the flask. The final denture is polished and adjusted to fit the stone master models.

Typical shrinkage during flasking is in the range of five percent. Rather than flasking both the denture plate and bite rim, if a final milled denture plate is used along with flasking of the bite rim, the shrinkage may be substantially less.

Some labs prefer to eliminate flasking. In these cases, if the lab has a milling machine, the final denture base and bite rim with teeth may be scanned, and a final denture base and bite rim may be milled from a single disk made of, for example, PMMA. Alternatively, the bite rim may be milled and affixed, with a suitable adhesive, to a separately milled denture base. A suitable cement is used to bond the denture teeth to the milled bite rim.

### Fabrication of Custom Esthetic Teeth

In one embodiment, as described above, traditional physical denture teeth are used to create the final dentures. In an alternative embodiment, esthetic custom denture teeth may be designed with varying color, translucency, and material properties. The custom teeth may be modeled with voxels, and their properties may vary on a voxel-by-voxel basis. Given suitable fabrication techniques and associated materials, labs may rapid manufacture (with, e.g., a 3D printer) a full denture complete with the pink plastic and the esthetic teeth.

### Digital Measurement

As described above, traditional techniques require a dentist to fit a patient with a base plate/bite rim combination to measure several parameters (e.g., horizontal plane, VDO, and VDR). In one embodiment, these measurements may be taken digitally. The digital measurements may be taken sooner in the process (e.g., at the first or second office visit) and may be more accurate than traditional measurements.

Digital sensors may be placed in a patient's mouth, and the dentist may adjust or otherwise manipulate the sensors into a natural position for that patient. For example, the sensors may be adjusted so that the patient's mouth closes to a degree consistent with closure using the final dentures. Once the sensors are adjusted, the dentist may manipulate the patient under a variety of conditions (e.g., jaw clenched, jaw relaxed, smiling, and frowning) and observe the output of the digital sensors in each case. In one embodiment, the output of the digital sensors is transmitted directly to a computer using a wired or wireless interface, and the dentist sends the collected output to a lab for processing.

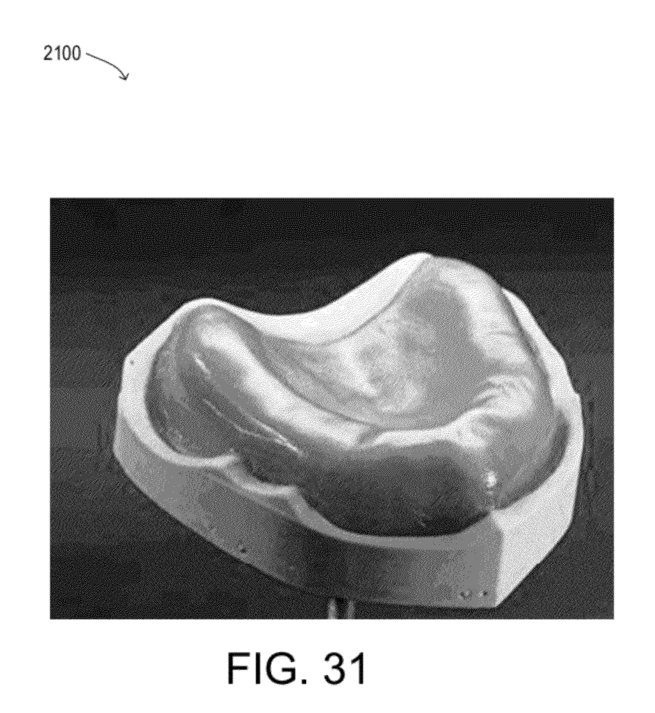

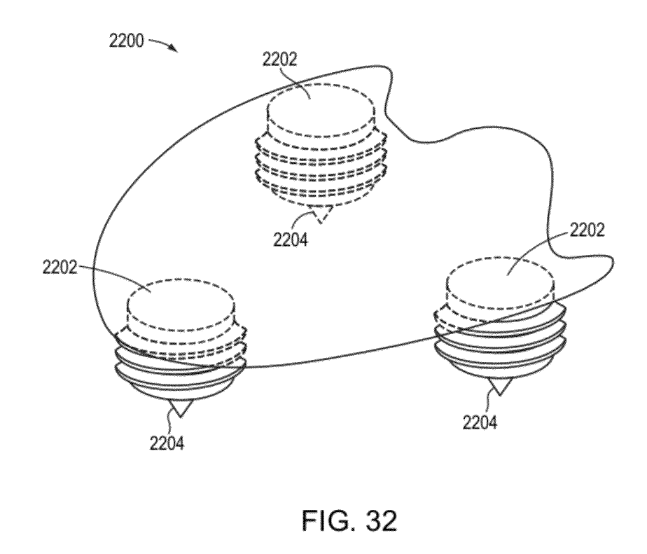

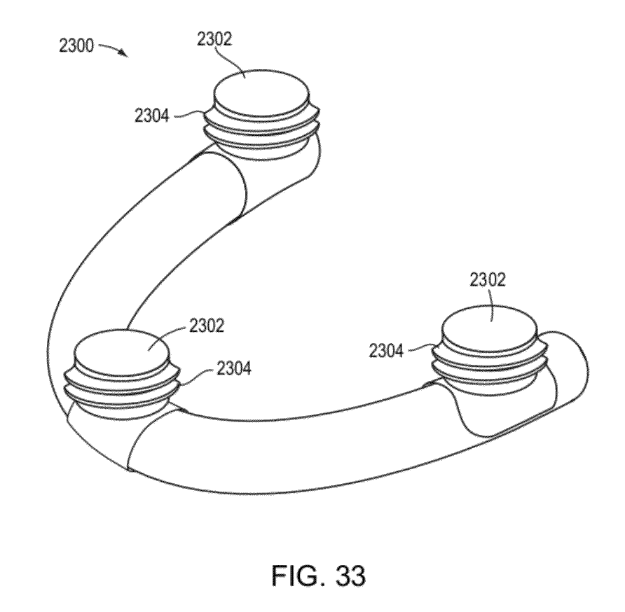

FIG. 31 illustrates a custom impression tray 2100 (made from, e.g., thermoplastic). Referring to FIG. 32, a sensor system 2200 includes digital sensors 2202, which may be attached to the custom impression tray 2100, to a denture base, or to any other convenient point of attachment in a patient's mouth. As depicted, the sensor system 2200 includes three sensors 2202, but any number of sensors 2202 may be used. Data from the sensors 2202 may be used to define a plane upon which points of the three sensors 2202 lie. The sensor system 2200 may be attached to a patient's upper jaw or lower jaw. A matching sensor system 2300, illustrated in FIG. 33, may be attached to the upper or lower jaw not already occupied by the sensor system 2200. Matching sensor system 2300 includes matching sensors 2304.

In one embodiment, the sensor system 2200 includes pointed tips, or styli, 2204. The tips 2204 contact with touch-sensitive areas 2302 in the sensors 2304, thereby creating a signal that may be digitized and corresponds to the location and force associated with the contact. The digital signal may be stored in the sensor systems 2200, 2300 and/or read out from an output port for external storage in, e.g., a computer. In an alternative embodiment, the sensors 2202, 2304 use a proximity-based sensing system, such as an ultrasound or infrared sensor.

The sensors or sensor posts 2202, 2304 may be adjustable to fit to a patient's mouth. In one embodiment, the height of all of the sensor posts is adjusted at the same time to allow for larger or smaller mouths. In another embodiment, individual sensor posts 2202, 2304 may be adjusted to change the pitch, roll, and/or yaw of the plane created by the meeting of the sensor surfaces 2204, 2302. The sensor posts 2202, 2304 may be adjusted manually or remotely. In one embodiment, the sensor posts 2202, 2304 include a thumbscrew, hydraulic cylinder, or air piston that may be manually controlled or remotely controlled (through, e.g., a wired or wireless interface). The sensor systems 2200, 2300 may be disposable and discarded after a single use or may be sterilized between uses.

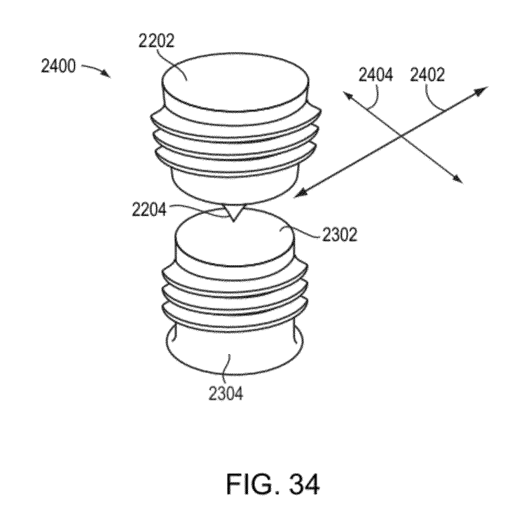

FIG. 34 shows a close up view 2400 of sensor posts 2202, 2304, tip 2204, and touch-sensitive area 2302. The sensors 2202, 2304 may be used to measure static and excursive movements, such as movements in a protrusive direction 2402 and movements in a lateral direction 2404. The sensors may be used to measure any one of horizontal plane with pitch, yaw and roll; upper and lower height to occlusal plane; face bow transfer (e.g., relation of the occlusal plane to the articulator hinge); smile line (i.e., a line that follows the shape of the patient's upper lip); canine to canine distance; midline; relaxed state (i.e., speaking or “freeway” space), typically 2-3 mm; excursive movements (e.g., 2D edge to edge, lateral, and protrusive); vertical dimension at occlusion (“VDO”); vertical dimension at rest (“VDR”); and any other relevant measurements.

A flat surface connected to the mandible (lower jaw) may be used for protrusive measurements, and the flat surface may use a digital touch-sensitive material to record the position of the mandible relative to the maxillary. Furthermore, static contact to register the position of the upper to the lower may be measured, as may excursive motions (protrusive, lateral). Any and all of these measurements may be recorded for digital playback on the virtual articulator.

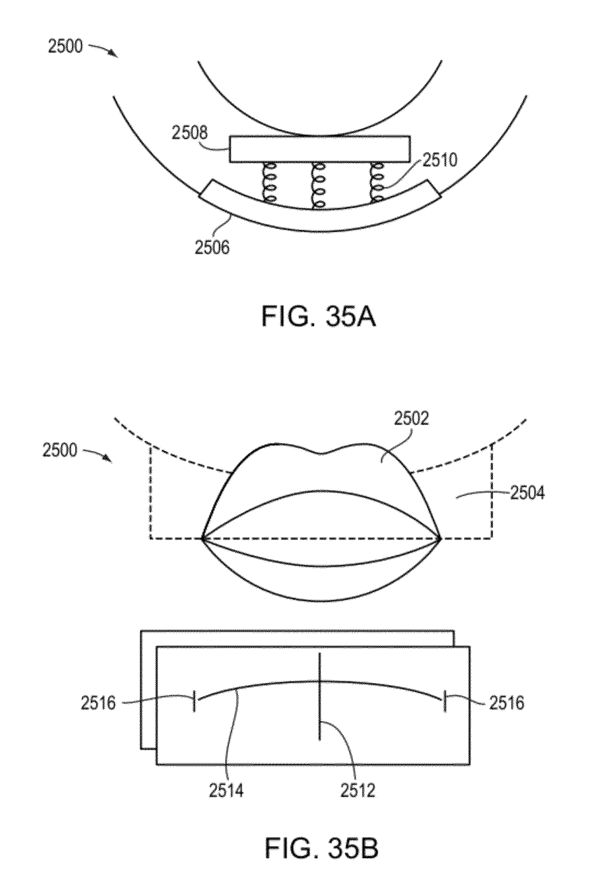

FIGS. 35a and 35b illustrate a system 2500 for smile-related and centric measurements (e.g., measurements related to the patient's face and/or lips). In general, a digital sensor measures the location and force of a patient's lips 2502 in various positions (e.g., smile, frown, relaxed). In one embodiment, a touch-sensitive material 2504 is placed in contact with the patient's lips 2502 for measurement thereof. In this embodiment, the touch-sensitive material 2504 is (or is placed on) a flexible, deformable bar 2506. The flexible bar 2506 is connected to a fixed bar 2508 via adjustable members 2510, and the fixed bar 2508 may be connected to the preliminary impression tray 2100, to a denture base, or to any other point in the patient's mouth. In one embodiment, the fixed bar 2508 replaces or is integrated with one of the sensor posts 2202, 2304.

Three adjustable members 2510 are shown, but any number of adjustable members 2510 may be used. In one embodiment, using three adjustable members 2510 permits a bowing adjustment of the flexible, deformable bar 2506. The flexible bar 2506 and the touch-sensitive material 2504 thereon may be used to record parameters such as midline 2512, smile line 2514, and canine position 2516, which may be marked by the dentist.

In one embodiment, the smile measurement device or system 2500 is embedded in the custom tray. In this embodiment, the custom tray may be 3D printed from the first impression with interface keys to the sensor components. The custom tray may be mated in a calibrated fashion with the sensor components, which may be disposable. As described above, the sensor components, in this embodiment or in the embodiments described above, may be used to measure and record the lateral and a/p plane orientation, smile line shape and position, location of the two canine teeth, mid-line location, protrusive and lateral excursive motion, and/or amount and shape of the lip protrusion. The embedded smile measurement device or system 2500 may communicate the measurements (e.g., wirelessly) to the design station so that the digital bite rim may be automatically designed.

### 3D Voxel Esthetic Tooth

As described above, esthetic teeth may be modeled using voxels. In one embodiment, each 3D point in space is modeled using voxels, and each voxel has multiple parameters including: color, translucency, material properties (e.g., hardness), viscosity, and/or properties to define interaction with adjacent voxels (e.g., spring and dampening). Color, shades, translucency, and phosphorescence may be captured from the patient digitally (if the patient has teeth).

Models may be fabricated using additive manufacturing that can produce a physical replica of each voxel with its associated properties. In one embodiment, the voxel-modeled tooth is input to a 3D printer (e.g., a rapid prototyper) that is implemented to use a voxel-based algorithm to manufacture a physical object. In this embodiment, the 3D printer creates the object by varying the properties of each voxel, on a voxel-by-voxel basis, in accordance with the parameters (e.g., hardness, viscosity, or color) set in the voxel model. Thus, the 3D printer can create a tooth that has a non-homogeneous composition or a graded structure with varying properties across the teeth and or baseplate (e.g., teeth having a hard enamel coating or denture bases with a resilient tissue surface and harder outer layer). 3D voxels may also be used for modeling and fabricating denture teeth, crowns, bridges, and/or temporaries.

### Fabrication of Base Plates

A biocompatible, rapid-manufactured base plate for positioning denture teeth allows a dentist to perform a try-in in a patient's mouth to guide the creation of partial or full dentures using standard techniques and materials. The biocompatible, digital denture base is an improvement over the standard manually constructed denture base in several ways. For example, it conforms more faithfully to the intended, designed shape of the patient situation as specified by the lab technician. This is because of features within the design software that allow the lab technician to use their experience to easily use the scanned 3D data of the stone to create a virtual refractory model. Software tools such as a “digital survey” tool may then be employed to easily add or remove precise undercut amounts from the virtual refractory.

In addition, the lab technician may directly indicate anatomical landmarks, such as the retro-molar pads and mid-line, and may easily find the correct bite planes and indicate the initial position for bite-rim wax or denture teeth setting by incorporating the landmarks into the 3D views in the design software. A denture base may be directly fabricated with undercuts. This is not generally possible in the standard lab practice without destroying the model to remove the base plate. As such, further adjustments may be made to the denture base shape by the dentist and these may be properly reflected in the final denture product. Specific features to accommodate the denture teeth may also be incorporated into the digital denture base. Rather than just using a strip of bite-rim wax to embed the denture teeth, the design software may use a built-in library of denture teeth to allow the digital denture base to have a designed shape that very closely approximates that of the final dentures. Gingival contours may be included as well as oversized holes that accommodate the root shapes from the denture teeth library.

The digital denture base may be designed using dental lab software. The input 3D data of the patient's mouth may be obtained through a scan of a patient model or impression, intra-oral scanning, CT-cone beam reconstruction, or other standard means.

The digital denture base is rapid manufactured—either through an additive process such as 3D printing, or through a subtractive process such as milling—in a biocompatible material. The biocompatible material for the denture base plate, may be, for example, an acrylic-based photopolymer such as FullCure®680, 720 resin from Objet Geometries Ltd. of Rehovot, Israel.

Denture teeth or bite-rim wax may be added to the printed denture base at the dental lab to aid the dentist in assessing the patient's bite. In one embodiment, a rapid manufacturing process is used for the actual denture teeth as well.

This preliminary denture assembly or “perfect try-in” may be inserted into the patient's mouth at the dentist's office and may be in contact with the patient's cheek, mouth, and gums for less than an hour. The dentist performs adjustments to the digital denture base, teeth position, or bite-rim wax to optimize the patient fit. The dentist then returns the whole preliminary denture assembly to the dental lab. The adjusted perfect try-in may be used to create the final denture at the dental lab through a well-known investment process known as flasking.

In the final flasking process, the digital denture base may be utilized in one of two ways—either temporary or permanent. In the temporary case, the adjusted digital denture base is used to form an impression in the flask for the shape of the base plate. This temporary base plate is then removed and discarded from the cast before the final acrylic or flexible material—such as, for example, Valplast—is injected into the flask. In the permanent case, the digital denture base remains in the flask and the final acrylic injection bonds the denture teeth directly to the adjusted, rapid manufactured, biocompatible base plate to create the final patient prosthesis.

In prior-art processes, when making a complete denture or removable partial denture, it is common for the dentist to perform a preliminary insertion or try-in to determine the fit, aesthetics, maxillomandibular relations, etc., before the final prosthesis is manufactured. For Valplast flexible dentures, the base plate for the try-in is often made of wax. In one embodiment of the present invention, the dental lab saves a step in their process because the dentist will test a designed shape directly in the patient with bite-rim wax and denture teeth included. For full dentures, it is common to create a base plate out of light cured plastic—such as Dentsply TRUBASE®—from an impression of the patient's tissue, and then set pre-made denture teeth into the base plate with bite-rim wax. Wax is then festooned around the necks of the teeth to create the natural looking gingival contours that match the teeth to the gum.

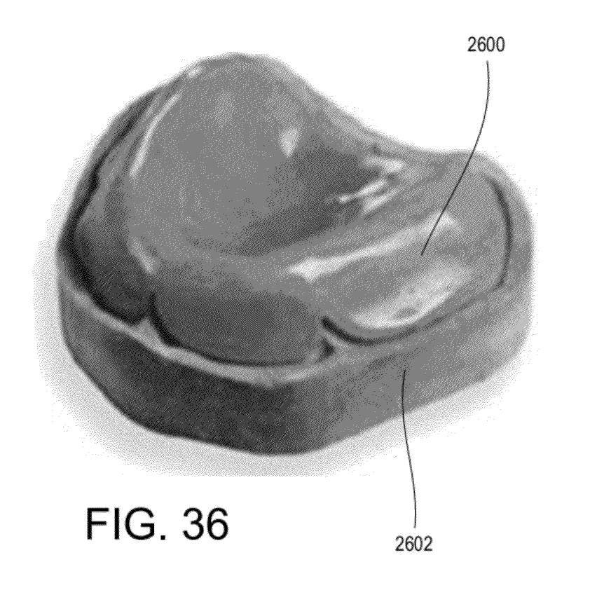

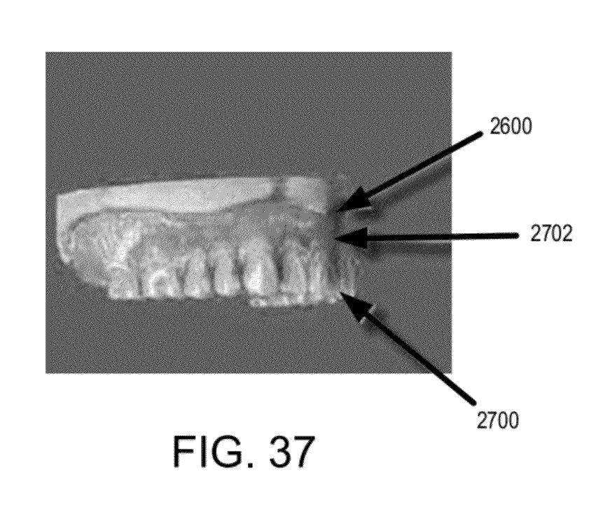

FIG. 36 shows a typical base plate 2600 made from Dentsply TRUBASE® material resting on a stone model 2602 made from the patient impression. FIG. 37 shows artificial denture teeth 2700 attached to the base plate 2600 and waxing 2702 used to create a natural looking gum line.

In another embodiment, the first manual step of making a base plate from wax or light-cured plastic is replaced with computer design wherein the dental stone is scanned to create a 3D virtual stone; computer design is done to create the base plate with gingival contours and oversized holes to accommodate pre-set teeth from a tooth library; and this design is then Rapid Manufactured in a biocompatible material. In another embodiment, a simple digital base plate is designed such that it is shaped to the virtual stone, but the gingival contours and holes to accommodate the denture teeth from the denture teeth library are omitted.

After the digital base plate has been rapid manufactured, either a bite-rim or denture teeth may be added to the base plate and this whole preliminary denture assembly (i.e., the perfect try-in), is sent to the dentist. The dentist then places the perfect try-in into the patient's mouth and adjusts the bite rim or individual tooth positions to maximize the appearance and function of the denture set and grinds the base plate to optimize the comfort or retention properties inside the patient's mouth. In another embodiment, a biocompatible perfect try-in is created through CAD/CAM that the dentist can place in the patient's mouth and adjust for fit. When the adjustments are complete, the dentist ships the adjusted perfect try-in back to the lab where standard techniques and materials are applied to create the final dentures for the patient.

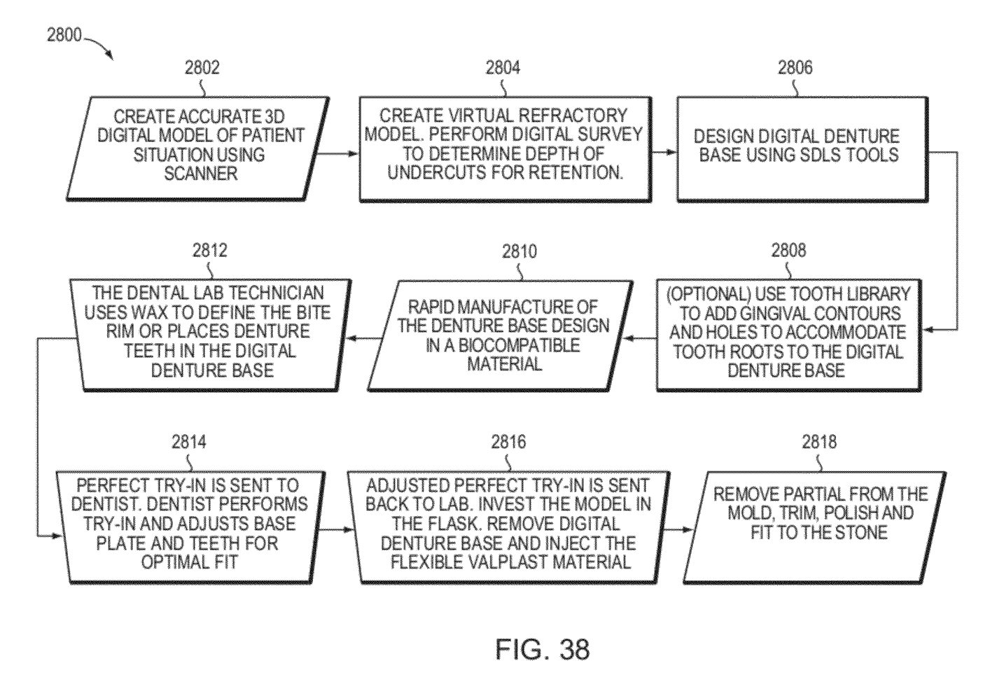

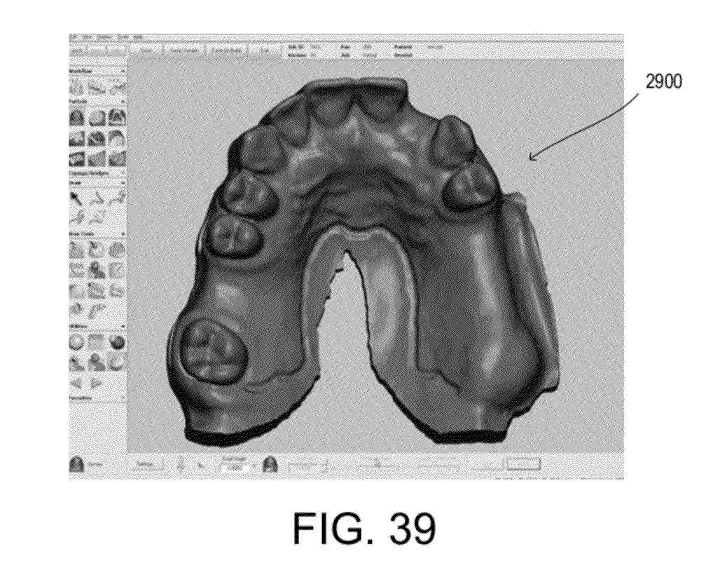

FIG. 38 illustrates a flowchart 2800 of the workflow steps to create a flexible partial denture using the digital denture base and perfect try-in. The first step (step 2802) is to scan the patient stone to obtain an accurate 3D model of the patient situation, such as the 3D model 2900 shown in FIG. 39. This scanning step may take many forms including: scanning of the patient impression, direct intra-oral scanning of the patient's teeth and tissues, or cone beam scanning of the patient's jaw, teeth and soft tissue.

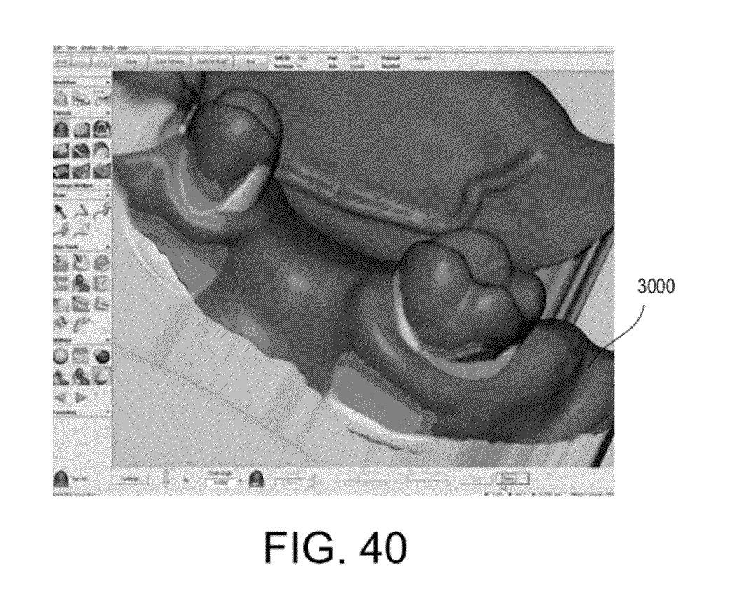

The 3D scanned data is used (step 2804) to create a virtual refractory model. The dental lab technician performs a digital survey to determine the depth of undercuts for ideal retention of a flexible partial 3000, as shown in FIG. 40.

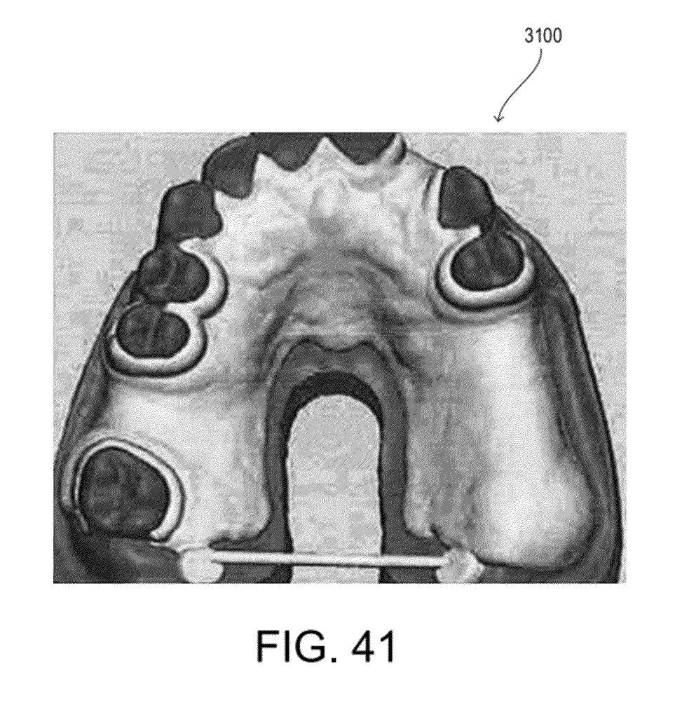

The dental lab design software may be used to create (step 2806) the shape for the digital denture base. The denture base may be further enhanced by using a tooth library to provide the shapes for the missing teeth. Once the teeth are positioned, the shapes may be again used as a “refractory” so that the gingival contours can be added and holes left to accommodate the roots of the denture teeth (step 2808). FIG. 41 shows a simple case 3100 in which the tooth library is not utilized.

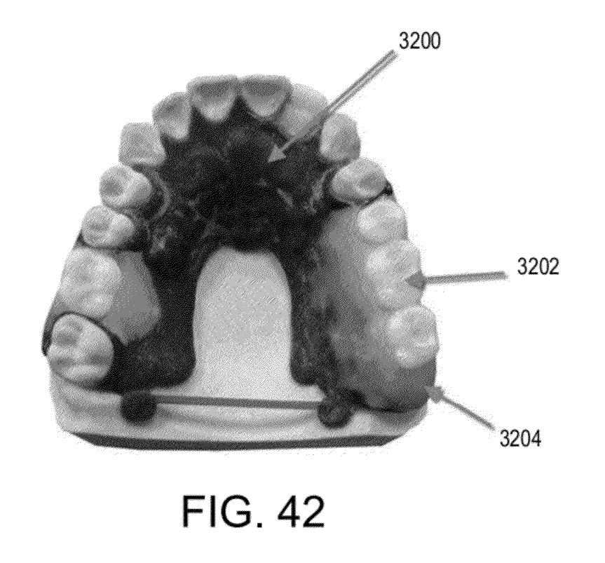

The base plate design is then rapid manufactured (step 2810) in a biocompatible material. Because, in one embodiment, the designed shape for a digital denture base 3200 does not include the gingival structure and holes to accommodate denture teeth 3202, wax 3204 may be used (step 2812) to set the denture teeth in the correct locations to create the perfect try-in, shown in FIG. 42.

The perfect try-in is sent (step 2814) to the dentist so he or she can test the fit within the patient's mouth. If the teeth need to be moved, the wax may be heated and the tooth positions adjusted. If the digital denture base shape needs to be modified, this modification may be done via grinding with a standard hand piece. After the dentist is satisfied that the perfect try-in fits the patient, it is sent back (step 2816) to the lab for final fabrication of the partial denture.

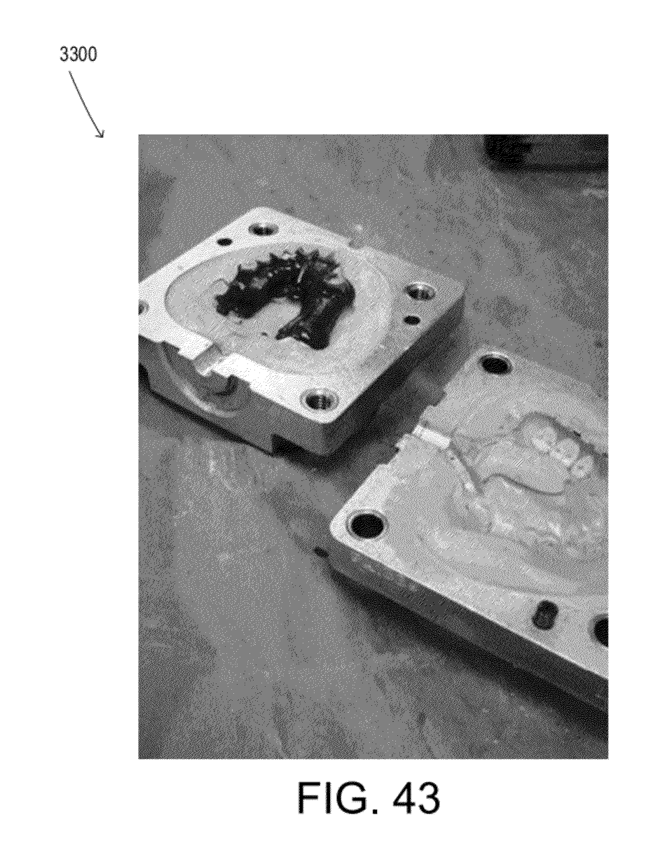

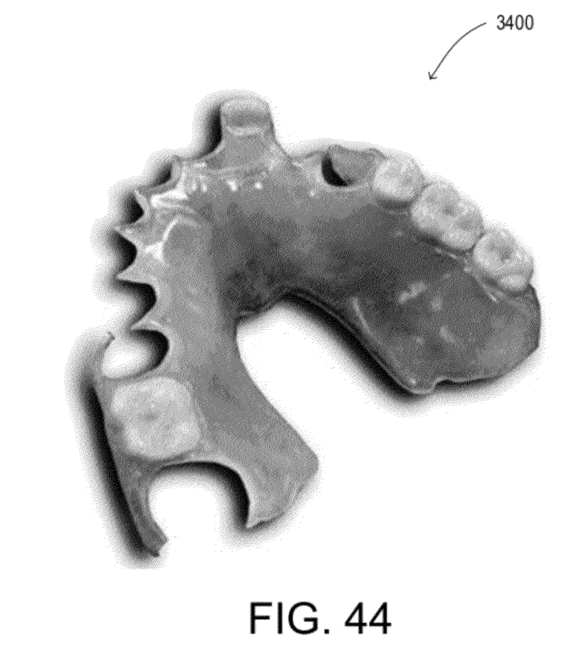

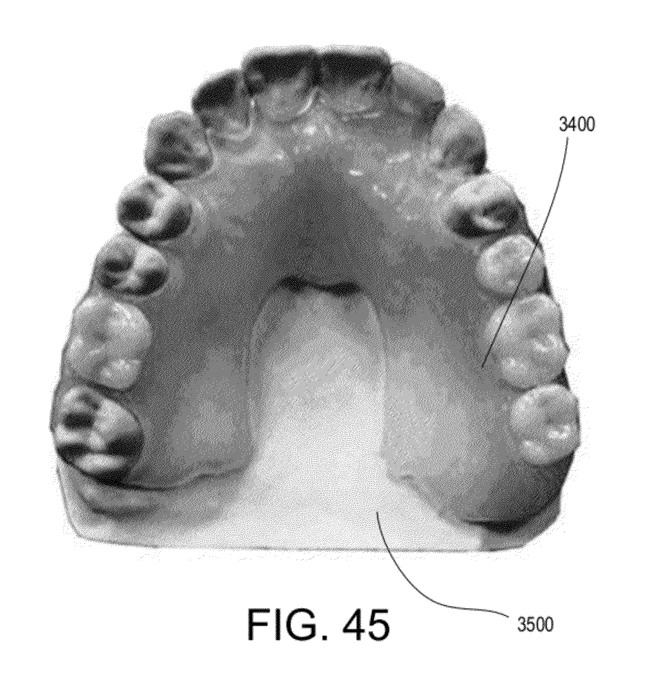

FIG. 43 shows the model invested in a flask 3300. The wax is boiled out and the flask 3300 is opened so that the digital denture base can be removed. The flask 3300 is then closed and the flexible material is injected. Finally, a flexible denture 3400 is removed from the mold and trimmed and polished (step 2818), as shown in FIG. 44. FIG. 45 shows the flexible denture 3400 fit back to an original stone 3500.

Primarily due to shrinkage during flasking, the final dentures may be placed in a physical articulator for final adjustments, usually by selectively grinding teeth to adjust the occlusion. If this is required, a master model may be printed or poured to ensure that the denture base with undercuts may be fit onto the master model without breakage. The denture base used for the try-in may not have undercuts, so that it can easily fit on the master model. A final denture base with undercuts may be created during flasking.

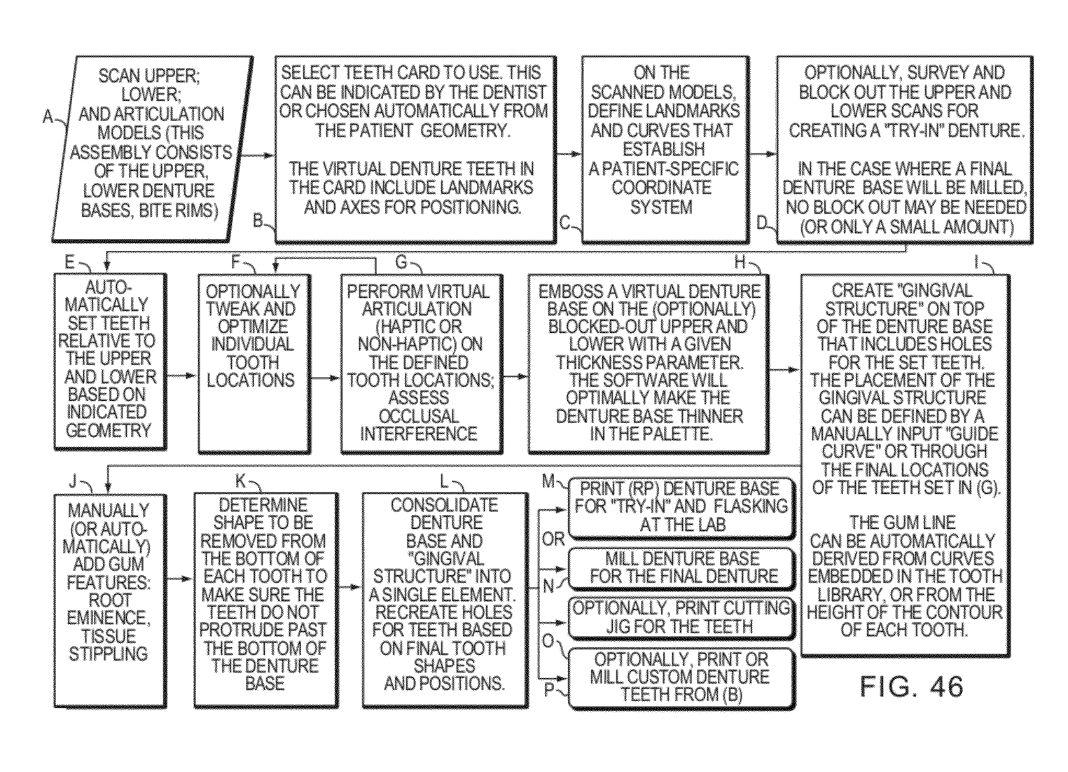

FIG. 46 is a flowchart depicting a method for producing dentures, in accordance with an embodiment of the invention. An assembly that includes an upper, a lower, denture bases, and bite rims is provided. The upper, the lower, and articulation models are scanned (step A). The articulation model assembly includes the upper, the lower, denture bases, and bite rims. The teeth card to be used is then selected (step B). The teeth card may be indicated by a dentist or chosen automatically from patient geometry. The virtual denture teeth in the card include landmarks and axes for positioning. Next, on the scanned articulation model, landmarks and curves are defined (step C) that establish a patient-specific coordinate system. For example, an occlusal curve may be defined from an upper bite rim, a mid-line, a high-lip (smile) line, and two cuspid lines. On the scanned upper and lower, a ridge line of a gum may be defined. As an optional step, the upper and lower scans are surveyed and blocked out (step D) for creating a try-in denture. In a case where a final denture base will be milled, no block out, or a small amount of block out, may be needed. Next, teeth are automatically set (step E) relative to the upper and lower, based on indicated geometry. Individual tooth locations may be tweaked and optimized (step F). As an optional step, virtual articulation (haptic or non-haptic) is then performed (step G) on the defined tooth locations, and occlusal interference is assessed. Individual tooth locations may again be tweaked and optimized, and virtual articulation may be repeated, as needed.

Still referring to FIG. 46, a virtual denture base is embossed (step H) on the upper and lower with a given thickness parameter. Optimally, the software will make the denture base thinner in the palette. Next, a gingival structure is created (step I) on top of the denture base that includes holes for the set teeth. The placement of the gingival structure can be defined by a manually input guide curve or through the final locations of the set teeth from step G. The gum line can be automatically derived from curves embedded in the tooth library, or from the height of the contour of each tooth. Gum features, such as root eminence and tissue stippling are then added (step J), either manually or automatically. The shape to be removed from the bottom of each tooth is then determined (step K) to make sure the teeth do not protrude past the bottom of the denture base. Next, the denture base and gingival structure are consolidated (step L) into a single element. Holes for the teeth are recreated, based on final tooth shapes and positions. A rapid prototype denture base may be printed (step M) for try-in and flasking at, for example, a lab. A denture base may be milled (step N) for the final denture. A cutting jig for the teeth may be printed (step O). As another optional step, denture teeth from step B may be printed and/or milled (step P).

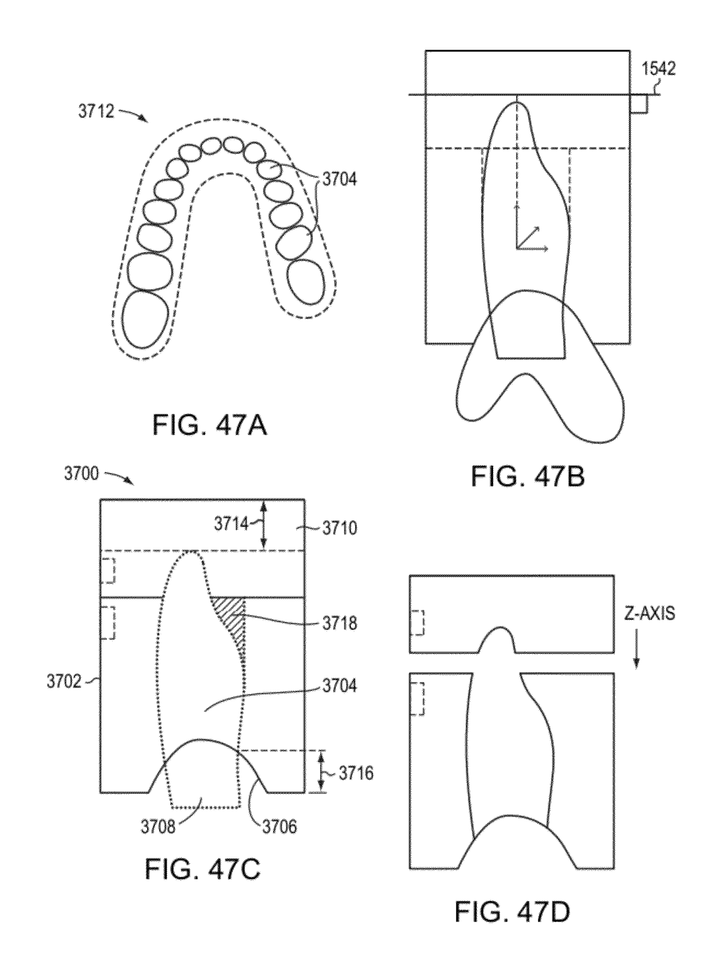

FIGS. 47a-d depicts schematic views of a cutting jig 3700 that may be used for method step O, above, in accordance with one embodiment of the invention. The cutting jig 3700 is a two piece design that includes a guide 3702 that holds or covers one or more denture teeth 3704. A bottom 3706 of the guide 3700 is shaped like the top of the gum line and exposes a shape or portion 3708 of the teeth 3704 to be removed via the dental handpiece. The cutting jig 3700 also includes a cap 3710 that holds the denture teeth 3704 securely in place within the guide 3700. Overall, the cutting jig 3700 may have the typical horseshoe shape 3712 of the bite rim. For reference, FIG. 47b depicts the occlusal plane 1542. Distances between the teeth 3704 and edges of the guide 3700 define a top height offset 3714 and a bottom height offset 3716. A block-out region 3718 may be included so that the teeth can be inserted into the cutting jig.

Embodiments of the invention may be used with methods and systems described in the following patents and/or applications, the texts of which are hereby incorporated by reference in their entirety: pending U.S. patent application Ser. No. 12/321,766, titled, “Haptically Enabled Dental Modeling System,” by Steingart et al., published as U.S. Patent Application Publication No. 2009/0248184; pending U.S. patent application Ser. No. 11/998,457, titled, “Systems for Haptic Design of Dental Restorations,” by Steingart et al., published as U.S. Patent Application Publication No. 2008/0261165.

Certain embodiments of the present invention were described above. It is, however, expressly noted that the present invention is not limited to those embodiments, but rather the intention is that additions and modifications to what was expressly described herein are also included within the scope of the invention. Moreover, it is to be understood that the features of the various embodiments described herein were not mutually exclusive and can exist in various combinations and permutations, even if such combinations or permutations were not made express herein, without departing from the spirit and scope of the invention. In fact, variations, modifications, and other implementations of what was described herein will occur to those of ordinary skill in the art without departing from the spirit and the scope of the invention. As such, the invention is not to be defined only by the preceding illustrative description.

A computer hardware apparatus may be used in carrying out any of the methods described herein. The apparatus may include, for example, a general purpose computer, an embedded computer, a laptop or desktop computer, or any other type of computer that is capable of running software, issuing suitable control commands, receiving graphical user input, and recording information. The computer typically includes one or more central processing units for executing the instructions contained in software code that embraces one or more of the methods described herein. The software may include one or more modules recorded on machine-readable media, where the term machine-readable media encompasses software, hardwired logic, firmware, object code, and the like. Additionally, communication buses and I/O ports may be provided to link any or all of the hardware components together and permit communication with other computers and computer networks, including the internet, as desired. The computer may include a memory or register for storing data.

In certain embodiments, the modules described herein may be software code or portions of software code. For example, a module may be a single subroutine, more than one subroutine, and/or portions of one or more subroutines. The module may also reside on more than one machine or computer. In certain embodiments, a module defines data (e.g., a bite rim curve) by creating the data, receiving the data, and/or providing the data. The module may reside on a local computer, or may be accessed via network, such as the Internet. Modules may overlap—for example, one module may contain code that is part of another module, or is a subset of another module.

The computer can be a general purpose computer, such as a commercially available personal computer that includes a CPU, one or more memories, one or more storage media, one or more output devices, such as a display, and one or more input devices, such as a keyboard. The computer operates using any commercially available operating system, such as any version of the Windows™ operating systems from Microsoft Corporation of Redmond, Wash., or the Linux™ operating system from Red Hat Software of Research Triangle Park, N.C. In some embodiments, a haptic device is present and is connected for communication with the computer, for example with wires. In other embodiments, the interconnection can be a wireless or an infrared interconnection. The haptic device is available for use as an input device and/or an output device. The computer is programmed with software including commands that, when operating, direct the computer in the performance of the methods of the invention. Those of skill in the programming arts will recognize that some or all of the commands can be provided in the form of software, in the form of programmable hardware such as flash memory, ROM, or programmable gate arrays (PGAs), in the form of hard-wired circuitry, or in some combination of two or more of software, programmed hardware, or hard-wired circuitry. Commands that control the operation of a computer are often grouped into units that perform a particular action, such as receiving information, processing information or data, and providing information to a user. Such a unit can comprise any number of instructions, from a single command, such as a single machine language instruction, to a plurality of commands, such as a plurality of lines of code written in a higher level programming language such as C++. Such units of commands are referred to generally as modules, whether the commands include software, programmed hardware, hard-wired circuitry, or a combination thereof. The computer and/or the software includes modules that accept input from input devices, that provide output signals to output devices, and that maintain the orderly operation of the computer. In particular, the computer includes at least one data input module that accepts information from the haptic device which is indicative of the state of the haptic device and its motions. The computer also includes at least one module that renders images and text on the display. In alternative embodiments, the computer is a laptop computer, a minicomputer, a mainframe computer, an embedded computer, or a handheld computer. The memory is any conventional memory such as, but not limited to, semiconductor memory, optical memory, or magnetic memory. The storage medium is any conventional machine-readable storage medium such as, but not limited to, floppy disk, hard disk, CD-ROM, and/or magnetic tape. The display is any conventional display such as, but not limited to, a video monitor, a printer, a speaker, an alphanumeric display, and/or a force-feedback haptic interface device. The input device is any conventional input device such as, but not limited to, a keyboard, a mouse, a force-feedback haptic interface device, a touch screen, a microphone, and/or a remote control. The computer can be a stand-alone computer or interconnected with at least one other computer by way of a network. This may be an internet connection.

### EQUIVALENTS

While the invention has been particularly shown and described with reference to specific preferred embodiments, it should be understood by those skilled in the art that various changes in form and detail may be made therein without departing from the spirit and scope of the invention as defined by the appended claims.

What is claimed is:

1. An apparatus for adjusting a position of one or more virtual teeth in a model of a set of dentures, the apparatus comprising:
(a) a memory for storing a code defining a set of instructions; and
(b) a processor for executing the set of instructions,
wherein the code comprises a graphical user interface (GUI) module configured to provide a graphical user interface element, the element comprising at least one active location for:
(i) translating one or more selected virtual teeth along a tooth direction axis;
(ii) rotating the one or more selected virtual teeth about the tooth direction axis;
(iii) translating the one or more selected virtual teeth along a buccal-lingual axis;
(iv) rotating the one or more selected virtual teeth about the buccal-lingual axis;
(v) translating the one or more selected virtual teeth along a tooth long axis; and
(vi) rotating the one or more selected virtual teeth about the tooth long axis.

2. The apparatus of claim 1, wherein the GUI module is configured to graphically display the one or more selected virtual teeth in relation to the tooth direction axis, the buccal lingual axis, and the tooth long axis.

3. The apparatus of claim 1, wherein the GUI module is configured to graphically display the one or more selected virtual teeth in relation to at least one of a direction curve and an occlusal plane.

4. The apparatus of claim 1, wherein the GUI module is configured to graphically display the one or more selected virtual teeth in relation to one another.

5. The apparatus of claim 1, wherein the buccal-lingual axis is substantially perpendicular to an occlusal plane normal and a bite rim curve.

6. The apparatus of claim 1, further comprising a display to graphically display the one or more selected virtual teeth.

7. An apparatus for automatically positioning virtual teeth in a model of a set of dentures, the apparatus comprising a memory for storing a code defining a set of instructions, and a processor for executing the set of instructions, wherein the code comprises a virtual tooth placement module configured to:
(a) define a bite rim curve, an occlusal plane, and a plurality of virtual teeth, wherein each of the virtual teeth is associated with a local coordinate system comprising:
a tooth direction axis;
a buccal-lingual axis; and
a tooth long axis; and
(b) position each virtual tooth in the set of dentures such that, for each virtual tooth, (i) the tooth direction axis is parallel to a line tangent to the bite rim curve and parallel to the occlusal plane, (ii) the buccal-lingual axis is perpendicular to the bite rim curve and parallel to the occlusal plane, and (iii) the tooth long axis is perpendicular to the bite rim curve.

8. The apparatus of claim 7, wherein the virtual tooth placement module is configured to position the origin for a virtual tooth onto the bite rim curve.

9. The apparatus of claim 7, wherein the virtual tooth placement module is configured to measure at least one of a lateral spacing between adjacent virtual teeth and a vertical spacing between opposing virtual teeth, and adjust at least one of the lateral spacing and the vertical spacing, to ensure virtual teeth do not overlap, the lateral spacing between virtual teeth is not excessive, and opposing virtual teeth are in contact but do not overlap.

10. The apparatus of claim 7, wherein the virtual tooth placement module is configured to translate a virtual tooth, in accordance with user input, along at least one of the tooth direction axis, the buccal-lingual axis, and the tooth long axis.

11. The apparatus of claim 7, wherein the virtual tooth placement module is configured to rotate a virtual tooth, in accordance with user input, about at least one of the tooth direction axis, the buccal-lingual axis, and the tooth long axis.

12. The apparatus of claim 7, wherein the virtual tooth placement module is configured to simulate a biting configuration between upper virtual teeth and lower virtual teeth, and calculate at least one of occlusal intereference and interference between adjacent teeth, based on the simulated biting configuration.

13. The apparatus of claim 7, further comprising a display to graphically display one or more virtual teeth.

14. The apparatus of claim 13, wherein the display is configured to display in color at least one of occlusal intereference and interference between adjacent teeth.

15. The apparatus of claim 7, wherein the virtual tooth placement module is configured to translate one or more virtual teeth until a cusp of a virtual tooth is centered within a groove of an opposing virtual tooth.

16. The apparatus of claim 7, wherein the virtual tooth placement module is configured to translate one or more virtual teeth until a cusp of a virtual tooth is centered within a groove of an opposing virtual tooth.

17. The apparatus of claim 7, wherein the virtual tooth placement module is configured to apply a tooth position macro to adjust the position of one or more virtual teeth.

18. The apparatus of claim 7, wherein a virtual tooth comprises a cusp, an opposing virtual tooth comprises a groove, and the virtual tooth placement module is configured to adjust a position of the virtual tooth to center the cusp within the groove.

19. An apparatus for automatically positioning virtual teeth in a model of a set of dentures, the apparatus comprising a memory for storing a code defining a set of instructions, and a processor for executing the set of instructions, wherein the code comprises a virtual tooth placement module configured to:
(a) define a bite rim curve, an occlusal plane, and a plurality of virtual teeth, wherein each of the virtual teeth is associated with a local coordinate system comprising a tooth direction axis; and
(b) position each tooth along the bite rim curve such that, for each tooth, the tooth direction axis is parallel to a line tangent to the bite rim curve.

20. The apparatus of claim 19, wherein the local coordinate system comprises a buccal-lingual axis, and wherein the virtual tooth placement module is configured to position each tooth such that, for each tooth, the buccal-lingual axis is perpendicular to the bite rim curve and parallel to the occlusal plane.

21. The apparatus of claim 19, wherein the local coordinate system comprises a long axis, and wherein the virtual tooth placement module is configured to position each tooth such that, for each tooth, the long axis is perpendicular to the bite rim curve and perpendicular to the occlusal plane.

22. A system for preparing a denture base plate for use in the preparation of dentures, the system comprising:
a user interface configured to receive input from a user;
a design application in communication with the user interface, wherein the design application is configured to create an initial virtual model using scan data corresponding to a stone or a patient situation, and wherein the design application comprises a virtual block-out wax tool configured to modify the initial virtual model by adding virtual block-out wax onto a user-defined region of the initial virtual model to partially or completely fill in one or more undercut portions of the model and to smooth irregularities on the surface of the initial virtual model, wherein the design application is configured to update the initial virtual model to include the added virtual block-out wax upon a user command, and is further configured to create a virtual denture base plate conforming to the updated virtual model; and
a manufacturing apparatus for fabrication of a denture base plate corresponding to the virtual denture base plate, wherein said manufacturing apparatus is capable of fabricating a denture base plate with one or more undercuts.

23. The system of claim 22, wherein the design application allows the user to specify a thickness of the virtual block out wax.

24. The system of claim 22, wherein the design application allows the user to specify a denture border.

25. The system of claim 22, wherein the manufacturing apparatus comprises a rapid prototyping machine.

26. The system of claim 22, wherein the manufacturing apparatus comprises a milling machine.

27. The system of claim 26, wherein the milling machine is for milling the denture base plate from a biocompatible material such as an acrylic, plastic, or various composite materials.

28. The system of claim 22, wherein the denture base plate comprises a final prosthetic.

29. The system of claim 22, wherein the denture base plate is used in a flasking step.

30. An apparatus for preparing a virtual denture base plate, the apparatus comprising:
(a) memory that stores code defining a set of instructions; and
(b) a processor that executes said instructions thereby to
(i) create a model from a scan of a dental model, dental impression, or a patient situation;
(ii) add virtual block-out wax to the model to fill in an undercut portion of the model, a defective portion of the model, or both; and
(iii) update the model to incorporate the added virtual block-out wax and virtual relief wax upon a user command, thereby preparing a virtual refractory model onto which a virtual denture base can be built.

31. The apparatus of claim 30, wherein the processor executes the instructions to update the model to incorporate denture border information, as specified by a user.

32. A method of preparing a denture base plate for use in the preparation of dentures, the method comprising:
(i) creating a model from a scan of a dental stone, dental impression, or a patient situation;
(ii) adding virtual block-out wax to the model to fill in an undercut portion of the model, a defective portion of the model, or both; and
(iii) updating the model to incorporate the added virtual block-out wax and virtual relief wax upon a user command, thereby preparing a virtual refractory model onto which a virtual denture base can be built.

33-49. (canceled)

50. A method for making dentures, the method comprising:
providing an upper model, a lower model, and an articulation model;
scanning the upper model, the lower model, and the articulation model to create a virtual scanned upper model, a virtual scanned lower model, and a virtual scanned articulation model;
selecting a teeth card;
defining an occlusal curve on the scanned articulation model;
defining curves on the scanned articulation model to establish a patient-specific coordinate system;
automatically positioning teeth from the selected teeth card relative to the scanned upper and lower models, based on indicated geometry;
adjusting a position of at least one tooth;
performing virtual articulation of the scanned upper and lower models with the positioned teeth to assess occlusal interference;
embossing a virtual denture base on the scanned upper and lower models;
creating a gingival structure on top of the virtual denture base that includes holes for the positioned teeth;
automatically deriving a gum line for the gingival structure from at least one of (i) curves embedded in a tooth library and (ii) a height of a tooth contour;
adding gum features to the gingival structure;
determining portions to be removed from the positioned teeth to ensure none of the positioned teeth protrude past a bottom of the denture base;
consolidating the denture base and the gingival structure into a consolidated denture base;
recreating holes for the teeth, based on final tooth shapes and positions; and
producing the consolidated denture base for try-in and final fitting to the patient.

51. The method of claim 50, comprising the step of milling or printing a physical denture base for flasking the denture, wherein the physical denture base is based on the consolidated denture base.

52. The method of claim 50, comprising the step of milling or printing a physical denture base for a final denture, wherein the physical denture base is based on the consolidated denture base.

53. The method of claim 50, comprising the step of milling or printing a cutting jig for shaping the teeth.

54. The method of claim 50, wherein the scanned upper and lower models are surveyed and blocked out for creating a try-in denture.

55. The method of claim 50, wherein the embossing step comprises making the denture base thinner in a palette.

56. The method of claim 50, wherein the gum features are added automatically.

57. The method of claim 50, wherein the teeth card is selected automatically.

58. The apparatus of claim 1, wherein the tooth direction axis is a mesial-distal direction axis.

59. The apparatus of claim 1, wherein the GUI module is configured to permit recording a series of user activities for repeated performance upon user command.

60. The apparatus of claim 1, wherein each of the axes is determined for each of the one or more virtual teeth using a bite rim wax scan and a lower jaw scan.

61. The apparatus of claim 1, wherein the GUI module is configured to allow user selection of multiple teeth and manipulation of more than one tooth at a time.

62. The apparatus of claim 61, wherein the GUI module is configured to allow user manipulation of a plurality of virtual teeth at a time, all with respect to the tooth direction axis, the buccal-lingual axis, and the tooth long axis of a single virtual tooth among the plurality of virtual teeth.

63. The apparatus of claim 61, wherein the GUI module is configured to allow user manipulation of a plurality of virtual teeth at a time, each tooth with respect to its own tooth direction axis, buccal-lingual axis, and tooth long axis.
